(19) United States
(12) Patent Application Publication
(10) Pub. No.: US 2024/0281840 A1
(43) Pub. Date: Aug. 22, 2024

(54) SENSOR SYSTEM AND COMPUTER-READABLE MEDIUM

(71) Applicant: Asahi Kasei Microdevices Corporation, Tokyo (JP)

(72) Inventors: Yuta TAKAGI, Tokyo (JP); Soichi MEJIMA, Tokyo (JP); Yuta MORIOKA, Tokyo (JP)

(21) Appl. No.: 18/440,969

(22) Filed: Feb. 14, 2024

(30) Foreign Application Priority Data
Feb. 17, 2023 (JP) 2023-023654

(51) Int. Cl. G06Q 30/0208; G01D 18/00

(52) U.S. Cl. CPC G06Q 30/0208; G01D 18/00

(57) ABSTRACT

There is provided a sensor system including a reward transmission unit which transmits a reward for calibration by a calibration unit. The calibration unit calibrates an environmental measurement value of a measurement target that is measured by a second environmental sensor, based on first calibration information for calibrating an environmental measurement value of a measurement target that is measured by a first environmental sensor. The sensor system may further include: a first sensor device having a calibration information transmission unit which transmits the first calibration information; and a second sensor device having a receiving unit which receives the first calibration information that is transmitted by the calibration information transmission unit, and the calibration unit.

The contents of the following patent application(s) are incorporated herein by reference: NO. 2023-023654 filed in JP on Feb. 17, 2023

### BACKGROUND

### 1. Technical Field

The present invention relates to a sensor system and a computer-readable medium.

### 2. Related Art

Patent Document 1 discloses that “with the present invention . . . it is possible to contribute to a society, and provide a benefit to each of a member, a card company, and an affiliated store” (Effect of the Invention). Patent Document 2 discloses that “a purpose is to perform effective sales promotion by providing a POS terminal with a prize function” (Abstract). Patent Document 3 discloses that “in the related art, it takes a long time to know a trend of variation rate of a pollution substance” (Abstract). Patent Document 4 discloses “easily issuing a coupon with a proper discount amount for each time printed thereon by changing the discount amount in accordance with the elapsed time” (Abstract). Patent Document 5 discloses that “capable of reflecting the discount rate corresponding to a value changing with time, to the payment in response to the change of time” (Abstract).

### PRIOR ART DOCUMENT

### Patent Document

Patent Document 1: Japanese Patent No. 5835734

Patent Document 2: Japanese Patent Application Publication No. 2005-056330

Patent Document 3: Japanese Patent Application Publication No. 2021-110475

Patent Document 4: Japanese Patent Application Publication No. 2009-230485

Patent Document 5: Japanese Patent Application Publication No. 2002-056467

### BRIEF DESCRIPTION OF THE DRAWINGS

FIG. 1 is a diagram showing an example of calibration of an environmental measurement value in a first sensor device 100 and a second sensor device 200, according to an embodiment of the present invention.

FIG. 2 is a block diagram showing an example of a sensor system 400 according to an embodiment of the present invention.

FIG. 3 is a diagram showing an example of a relationship between the first sensor device 100 and a measurement target 502 in the sensor system 400.

FIG. 4 is a diagram showing another example of the relationship between the first sensor device 100 and the measurement target 502 in the sensor system 400.

FIG. 5 is a diagram showing another example of the relationship between the first sensor device 100 and the measurement target 502 in the sensor system 400.

FIG. 6 is a diagram showing another example of the relationship between the first sensor device 100 and the measurement target 502 in the sensor system 400.

FIG. 7 is a diagram showing another example of the relationship between the first sensor device 100 and the measurement target 502 in the sensor system 400.

FIG. 8 is a diagram showing another example of the relationship between the first sensor device 100 and the measurement target 502 in the sensor system 400.

FIG. 9 is a diagram showing another example of the relationship between the first sensor device 100 and the measurement target 502 in the sensor system 400.

FIG. 10 is a diagram showing another example of the relationship between the first sensor device 100 and the measurement target 502 in the sensor system 400.

FIG. 11 is a flowchart showing an example of a method according to an embodiment of the present invention.

FIG. 12 shows an example of a detail of a calibration step S104 in FIG. 11.

FIG. 13 is a diagram showing an example of a computer 2200 in which the sensor system 400 according to an embodiment of the present invention may be implemented in whole or in part.

### DESCRIPTION OF EXEMPLARY EMBODIMENTS

Hereinafter, the present invention will be described through embodiments of the invention, but the following embodiments do not limit the invention according to claims. In addition, not all combinations of features described in the embodiment are essential to the solution of the invention.

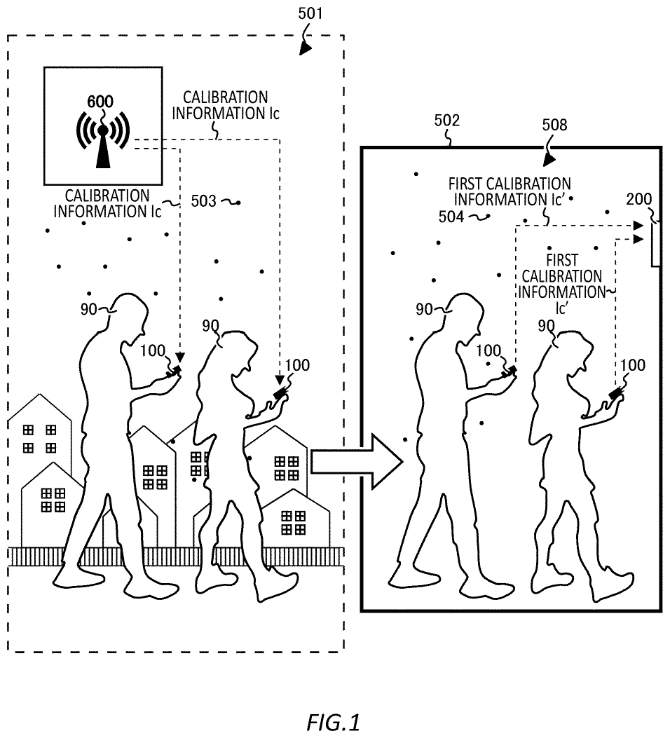

FIG. 1 is a diagram showing an example of calibration of an environmental measurement value in a first sensor device 100 and a second sensor device 200, according to an embodiment of the present invention. In the present example, a measurement target 501 is outdoors, and a measurement target 502 is a store.

In the present example, a living body 90 has the first sensor device 100. The first sensor device 100 may be a mobile terminal. The living body 90 is, for example, a human being. FIG. 1 shows a situation in which the living body 90 having the first sensor device 100 moves from the measurement target 501 to the measurement target 502. When the measurement target 502 is the store, the store may be a store of a business that provides food and beverages, such as a restaurant.

A target substance 503 exists in the measurement target 501. The target substance 503 is a substance that is a measurement target of a first environmental sensor 11 (described below). The target substance 503 is a substance that can represent an environmental state of the measurement target 501. The target substance 503 may be a substance that can affect a life activity of the living body 90.

The target substance 503 is, for example, a gas. The gas may be a CO₂ (carbon dioxide) gas, may be a CH₄ (methane) gas, or may be alcohol. The target substance 503 may be NOₓ (nitrogen oxide) or SOₓ (sulfur oxide), or may be a PM (particle matter). The measurement target of the first environmental sensor 11 (described below) may be temperature, humidity, or atmospheric pressure of the measurement target 501.

An environmental sensor 600 may be arranged in the measurement target 501. The environmental sensor 600 measures a physical quantity in relation to an environment of the measurement target 501. The physical quantity in relation to the environment of the measurement target 501 is, for example, a concentration of the target substance 503 in the measurement target 501, or the temperature, the humidity, or the atmospheric pressure of the measurement target 501. When the measurement target 501 is outdoors, the environmental sensor 600 measures the target substance 503 in an atmosphere outdoors, or measures the temperature, the humidity, or the atmospheric pressure outdoors. The physical quantity in relation to the environment of the measurement target 501, which is measured by the environmental sensor 600, is set as an environmental measurement value Ve0.

When the target substance 503 is the gas, the environmental sensor 600 is a gas sensor, and the environmental measurement value Ve0 is a gas concentration. When the target substance 503 is NOₓ (nitrogen oxide), SOₓ (sulfur oxide), or the PM (particle matter), the environmental sensor 600 is each of a NOₓ (nitrogen oxide) sensor, a SOₓ (sulfur oxide) sensor, or a PM sensor. When the environmental sensor 600 is the NOₓ (nitrogen oxide) sensor, the SOₓ (sulfur oxide) sensor, or the PM sensor, the environmental measurement value Ve0 is each of a NOₓ (nitrogen oxide) concentration, a SOₓ (sulfur oxide) concentration, or a PM concentration.

When the environmental sensor 600 is a CO₂ (carbon dioxide) sensor, the environmental sensor 600 may be an optical element; may be the CO₂ (carbon dioxide) sensor by an NDIR (Non Dispersive InfraRed) method; may be the CO₂ (carbon dioxide) sensor by photoacoustic spectroscopy; may be the CO₂ (carbon dioxide) sensor which detects a CO₂ (carbon dioxide) gas by a solid electrolyte; or may be the CO₂ (carbon dioxide) sensor by MEMS (Micro Electro Mechanical Systems).

When the environmental sensor 600 measures the temperature, the humidity, or the atmospheric pressure of the measurement target 501, the environmental sensor 600 is each of a temperature sensor, a humidity sensor, or a pressure sensor. When the environmental sensor 600 is the temperature sensor, the humidity sensor, or the pressure sensor, the environmental measurement value Ve0 is each of the temperature, the humidity, or the atmospheric pressure of the measurement target 501.

A target substance 504 exists in an interior space 508 in the measurement target 502. The target substance 504 is a substance that is a measurement target of a second environmental sensor 21 (described below). The target substance 504 is a substance that can represent an environmental state of the measurement target 502. The target substance 504 may be a substance that can affect the life activity of the living body 90. Similar to the target substance 503, the target substance 504 is, for example, the gas, NOₓ (nitrogen oxide), SOₓ (sulfur oxide), the PM (particle matter), or the like. The measurement target of the second environmental sensor 21 (described below) may be the temperature, the humidity, or the atmospheric pressure of the interior space 508 in the measurement target 502.

The interior space 508 may be a space isolated from the measurement target 501. The interior space 508 may be a closed space. When the measurement target 502 is the store, the interior space 508 is, for example, a room in the store.

The second sensor device 200 is arranged in the measurement target 502. In the present example, the second sensor device 200 is arranged in the interior space 508. The second sensor device 200 may be the mobile terminal.

A characteristic of the environmental sensor 600 may change over time. When the environmental sensor 600 is the CO₂ (carbon dioxide) sensor, the CO₂ (carbon dioxide) sensor may be the optical element. The characteristic of the optical element or the like, and the characteristic of an electronic circuit into which a measurement value by the CO₂ (carbon dioxide) sensor is input may change over time. Therefore, it is preferable for the CO₂ (carbon dioxide) sensor to be calibrated. In the present example, it is assumed that the environmental sensor 600 is calibrated. The fact that the environmental sensor 600 is calibrated means that when the environmental sensor 600 is the gas sensor, the environmental sensor 600 is in a state of being able to measure a true value of the gas concentration of the measurement target 501. The same applies to a case where the environmental sensor 600 is the NOₓ (nitrogen oxide) sensor, the SOₓ (sulfur oxide) sensor, the PM sensor, the temperature sensor, the humidity sensor, or the pressure sensor.

The environmental sensor 600 may transmit calibration information in relation to the calibration of the environmental sensor 600. The calibration information is set as calibration information Ic. The calibration information Ic is information for calibrating the environmental measurement value Ve0 of the measurement target 501 by the environmental sensor 600. When the environmental sensor 600 measures the concentration of the target substance 503, the calibration information Ic is information for calibrating a measurement value of the concentration of the target substance 503 by the environmental sensor 600. When the environmental sensor 600 measures the concentration of the target substance 503, the calibration information Ic is information in relation to the calibration for bringing the measurement value of the concentration of the target substance 503 closer to the true value of the concentration.

When the environmental sensor 600 measures the temperature, the humidity, or the atmospheric pressure of the measurement target 501, the calibration information Ic is information for calibrating each of the measurement values of the temperature, the humidity, or the atmospheric pressure of the measurement target 501 by the environmental sensor 600. When the environmental sensor 600 measures the temperature, the humidity, or the atmospheric pressure of the measurement target 501, the calibration information Ic is information in relation to the calibration for bringing each of the measurement values of the temperature, the humidity, or the atmospheric pressure of the measurement target 501 by the environmental sensor 600 closer to the true value of the temperature, the true value of the humidity, the true value of the atmospheric pressure.

The calibration information Ic may be a digital signal that is calculated based on an analog output signal of the environmental sensor 600. The environmental sensor 600 may wirelessly transmit the calibration information Ic to an open space in the measurement target 501.

The calibration information Ic may be an indication value of the environmental measurement value Ve0 in the measurement target 501 (refer to FIG. 1).

The calibration information Ic may be an amount of calibration of the environmental measurement value Ve0 in the measurement target 501 (refer to FIG. 1).

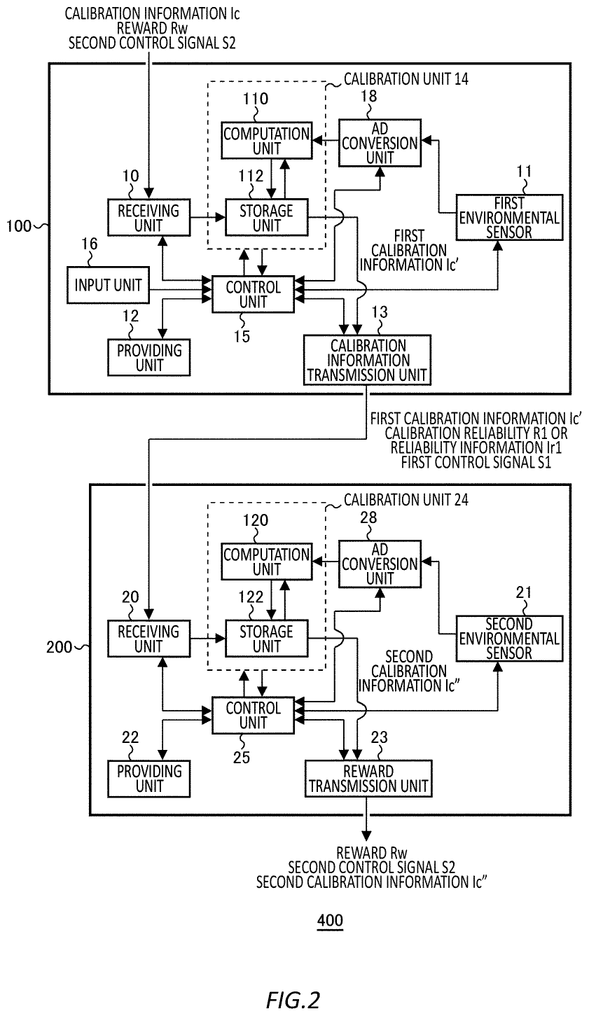

FIG. 2 is a block diagram showing an example of a sensor system 400 according to an embodiment of the present invention. The sensor system 400 includes a reward transmission unit 23. The sensor system 400 may include the first sensor device 100 and the second sensor device 200. In the present example, the second sensor device 200 has the reward transmission unit 23. The sensor system 400 may include a calibration unit 24. In the present example, the second sensor device 200 has the calibration unit 24.

The first sensor device 100 may have a calibration information transmission unit 13. The first sensor device 100 may include a receiving unit 10, a control unit 15, a calibration unit 14, an input unit 16, and a providing unit 12. The first sensor device 100 may include the first environmental sensor 11 and an AD conversion unit 18.

The control unit 15 is, for example, a central processing unit (CPU). The first sensor device 100 may be the mobile terminal including the CPU. The mobile terminal may include a portable computer such as a smartphone or a tablet. The first sensor device 100 may be the mobile terminal including the CPU, a memory, an interface, and the like.

The providing unit 12 is, for example, a display, a monitor, or the like. The providing unit 12 may be a speaker. When the first sensor device 100 is the mobile terminal, the providing unit 12 may be the display of the mobile terminal, or may be the speaker. When the first sensor device 100 is the mobile terminal, the providing unit 12 may be a vibration providing unit which provides a vibration to the mobile terminal.

The first environmental sensor 11 measures the physical quantity in relation to the environment of the measurement target 501. The physical quantity that is measured by the first environmental sensor 11 and that relates to the environment of the measurement target 501, is set as an environmental measurement value Ve1.

The physical quantity that is measured by the first environmental sensor 11 may be an analog signal. The AD conversion unit 18 converts, into the digital signal, the analog signal that is output by the first environmental sensor 11.

When the target substance 503 is the gas, the first environmental sensor 11 is the gas sensor, and the environmental measurement value Ve1 is the gas concentration. When the target substance 503 is NOₓ (nitrogen oxide), SOₓ (sulfur oxide), or the PM (particle matter), the first environmental sensor 11 is each of the NOₓ (nitrogen oxide) sensor, the SOₓ (sulfur oxide) sensor, or the PM sensor. When the first environmental sensor 11 is the NOₓ (nitrogen oxide) sensor, the SOₓ (sulfur oxide) sensor, or the PM sensor, the environmental measurement value Ve1 is each of the NOₓ (nitrogen oxide) concentration, the SOₓ (sulfur oxide) concentration, or the PM concentration.

When the first environmental sensor 11 measures the temperature, the humidity, or the atmospheric pressure of the measurement target 501, the first environmental sensor 11 is each of the temperature sensor, the humidity sensor, or the pressure sensor. When the first environmental sensor 11 is the temperature sensor, the humidity sensor, or the pressure sensor, the environmental measurement value Ve1 is each of the temperature, the humidity, or the atmospheric pressure of the measurement target 501.

The characteristic of the first environmental sensor 11 may change over time. Therefore, it is preferable for the first environmental sensor 11 to be calibrated. In the present example, the receiving unit 10 receives the calibration information Ic that is transmitted by the environmental sensor 600. The calibration unit 14 calibrates the environmental measurement value Ve1 that is measured by the first environmental sensor 11, based on the calibration information Ic. In this manner, the environmental measurement value Ve1 by the first environmental sensor 11 easily becomes a value more accurate than that before the calibration. The calibration unit 14 may calibrate the environmental measurement value Ve1 in a state in which the first sensor device 100 is arranged in the measurement target 501 (in the present example, in a state in which the living body 90 exists outdoors). The providing unit 12 may be provided with information indicating that the calibration unit 14 is calibrating the environmental measurement value Ve1 or information indicating that the calibration is completed.

The calibration unit 14 may include a computation unit 110 and a storage unit 112. The computation unit 110 may calculate the environmental measurement value Ve1, based on the digital signal converted by the AD conversion unit 18. In the present example, the environmental measurement value Ve1 that is measured by the first environmental sensor 11 refers to the environmental measurement value Ve1 that is calculated by the computation unit 110.

The storage unit 112 stores the environmental measurement value Ve1 calculated by the computation unit 110. The storage unit 112 may store a correlation between the environmental measurement value Ve1 calculated by the computation unit 110 and the calibration information Ic. The correlation is set as a correlation Cr. The correlation Cr may be a correlation function, or may be a correlation table.

The calibration information for calibrating the environmental measurement value Ve1 is referred to as first calibration information Ic′. The computation unit 110 may compute the first calibration information Ic′, based on the calibration information Ic received by the receiving unit 10 and the correlation Cr stored in the storage unit 112. The first calibration information Ic′ is information in relation to the calibration for bringing the environmental measurement value Ve1 closer to the true value of the environmental measurement value Ve1. The first calibration information Ic′ may be different from the calibration information Ic, or may match the calibration information Ic.

The computation unit 110 is, for example, a central processing unit (CPU). The computation unit 110 and the control unit 15 may be a single CPU.

The calibration information transmission unit 13 transmits the first calibration information Ic′. When the living body 90 (refer to FIG. 1) remains in the measurement target 501 (refer to FIG. 1), the calibration information transmission unit 13 may transmit the first calibration information Ic′ to the open space in the measurement target 501. When the living body 90 moves from the measurement target 501 to the measurement target 502 (refer to FIG. 1), the calibration information transmission unit 13 may transmit the first calibration information Ic′ to the interior space 508. The calibration information transmission unit 13 may wirelessly transmit the first calibration information Ic′.

In a case where the first sensor device 100 does not have the first environmental sensor 11, the first sensor device 100 may not have the AD conversion unit 18. In a case where the first sensor device 100 does not have the first environmental sensor 11 and the AD conversion unit 18, the output analog signal of the first environmental sensor 11 may be converted into the digital signal by the AD conversion unit 18 arranged outside the first sensor device 100. The digital signal converted by the AD conversion unit 18 may be transmitted to the first sensor device 100. The same applies to a case where the second sensor device 200 does not have the second environmental sensor 21 (described below).

The first calibration information Ic′ may be an indication value of the environmental measurement value Ve1 in the measurement target 501 (refer to FIG. 1), or may be an amount of calibration of the environmental measurement value Ve1. The amount of calibration of the environmental measurement value Ve1 may be a difference between the environmental measurement value Ve0 and the environmental measurement value Ve1.

The second sensor device 200 may include the reward transmission unit 23. The second sensor device 200 may include a receiving unit 20, a calibration unit 24, a control unit 25, and a providing unit 22. The second sensor device 200 may include a second environmental sensor 21 and an AD conversion unit 28. The functions of the control unit 25, the providing unit 22, and the AD conversion unit 28 may be the same as those of the control unit 15, the providing unit 12, and the AD conversion unit 18 in the first sensor device 100, respectively.

The second environmental sensor 21 measures a physical quantity in relation to an environment of the measurement target 502 (refer to FIG. 1). The physical quantity that is measured by the second environmental sensor 21 and that relates to the environment of the measurement target 502, is set as an environmental measurement value Ve2. The function and the characteristic of the second environmental sensor 21 may be the same as the function and the characteristic of the first environmental sensor 11.

The receiving unit 20 receives the first calibration information Ic′ that is transmitted by the calibration information transmission unit 13 of the first sensor device 100. The calibration unit 24 calibrates the environmental measurement value Ve2, based on the first calibration information Ic′ received by the receiving unit 20. In this manner, the environmental measurement value Ve2 by the second environmental sensor 21 easily becomes a value more accurate than that before the calibration.

As described above, the first calibration information Ic′ is calibration information for calibrating the environmental measurement value Ve1. When the calibration unit 14 calibrates the environmental measurement value Ve1 in the state in which the first sensor device 100 is arranged in the measurement target 501 (refer to FIG. 1) (in the present example, in the state in which the living body 90 exists outdoors), and the first sensor device 100 moves from the measurement target 501 to the measurement target 502 (refer to FIG. 1), there is a high probability that the first environmental sensor 11 can accurately measure the physical quantity in relation to the environment of the measurement target 502. Therefore, it becomes easy for the calibration unit 24 of the second sensor device 200 to accurately calibrate the environmental measurement value Ve2, based on the first calibration information Ic′.

The calibration unit 24 may include a computation unit 120 and a storage unit 122. The computation unit 120 may calculate the environmental measurement value Ve2, based on the digital signal converted by the AD conversion unit 28. In the present example, the environmental measurement value Ve2 that is measured by the second environmental sensor 21 refers to the environmental measurement value Ve2 that is calculated by the computation unit 120.

The storage unit 122 stores the environmental measurement value Ve2 calculated by the computation unit 120. The storage unit 122 may store a correlation between the environmental measurement value Ve2 calculated by the computation unit 120 and the first calibration information Ic′. The correlation is set as a correlation Cr′. The correlation Cr′ may be a correlation function, or may be a correlation table.

The calibration information for calibrating the environmental measurement value Ve2 is referred to as second calibration information Ic″. The computation unit 120 may calculate the second calibration information Ic″, based on the first calibration information Ic′ received by the receiving unit 20 and the correlation Cr′ stored in the storage unit 122. The second calibration information Ic″ is information in relation to the calibration for bringing the environmental measurement value Ve2 closer to the true value of the environmental measurement value Ve2. The second calibration information Ic″ may be different from the first calibration information Ic′, or may match the first calibration information Ic′.

The computation unit 120 is, for example, a CPU (Central Processing Unit). The computation unit 120 and the control unit 25 may be a single CPU.

The environmental measurement value Ve2 may deviate from the true value of the environmental measurement value Ve2. In the sensor system 400 of the present example, the receiving unit 10 receives the calibration information Ic in the state in which the first sensor device 100 is arranged in the measurement target 501 (in the present example, the state in which the living body 90 exists outdoors), and the computation unit 110 calculates the first calibration information Ic′ based on the received calibration information Ic. Therefore, when the living body 90 moves from the measurement target 501 (refer to FIG. 1) to the interior space 508 (refer to FIG. 1), it becomes easy for the first sensor device 100 to accurately measure the environmental measurement value Ve2 in the interior space 508.

In the sensor system 400 of the present example, after the living body 90 moves from the measurement target 501 to the measurement target 502, the receiving unit 20 receives the first calibration information Ic′, and the calibration unit 24 calibrates the environmental measurement value Ve2 that is measured by the second environmental sensor 21 based on the first calibration information Ic′. This makes it possible for the sensor system 400 to calibrate the environmental measurement value Ve2, even when it is difficult for the second sensor device 200 to perform self-calibration on the second environmental sensor 21. The providing unit 22 may be provided with information indicating that the calibration unit 24 is calibrating the environmental measurement value Ve2 or information indicating that the calibration is completed.

The reward transmission unit 23 transmits a reward for the calibration by the calibration unit 24. The reward is referred to as a reward Rw. When the measurement target 502 is the store, the reward Rw is a reward for contributing to the calibration of the second environmental sensor 21 which is arranged in the store. The contributing to the calibration of the second environmental sensor 21 refers to transmitting the first calibration information Ic′ to the second sensor device 200, that is, providing the first calibration information Ic′. The reward transmission unit 23 may further transmit the second calibration information Ic″.

When the measurement target 502 is the store, the interior space 508 (refer to FIG. 1) may be a closed space isolated from the outdoors. When the interior space 508 is the closed space, it may be difficult for the second sensor device 200 to perform the self-calibration on the second environmental sensor 21. When the second environmental sensor 21 is not calibrated, the second environmental sensor 21 may provide the environmental measurement value Ve2 that is incorrect. Therefore, the second environmental sensor 21 may provide incorrect information to a customer who is considering entering the store in relation to the measurement target 502. This may cause a disadvantage to the store, such as the customer hesitating or stopping entering into the store.

In the sensor system 400, the environmental measurement value Ve2 is calibrated, based on the first calibration information Ic′. Therefore, when the measurement target 502 is the store, the second environmental sensor 21 can provide accurate information to the customer who is considering entering the store. Therefore, the customer can easily enter the store at ease. This makes it possible for the store to avoid an opportunity loss of business. The reward transmission unit 23 transmits the reward Rw for contributing to the calibration of the second environmental sensor 21.

The reward transmission unit 23 may transmit the reward Rw at a predetermined timing. The predetermined timing may refer to a timing after the calibration, or may refer to a predetermined date (for example, an end of a month).

The reward Rw may be a point, a coupon such as a gift certificate or a discount coupon, a credit score, or the like. The credit score is, for example, data obtained by converting, into a score, calibration reliability R1 (described below) of the first calibration information Ic′. The reward Rw may be a point, a coupon such as a gift certificate or a discount coupon, or information for assigning a credit score. For example, the reward Rw may be a URL (Uniform Resource Locator) of a site where the coupon can be obtained on the Internet.

The measurement target 502 of which the environmental measurement value Ve2 is measured by the first environmental sensor 11, and the measurement target 502 of which the environmental measurement value Ve2 is measured by the second environmental sensor 21, may be the same as each other. The fact that the measurement target 502 of which the environmental measurement value Ve2 is measured by the first environmental sensor 11, and the measurement target 502 of which the environmental measurement value Ve2 is measured by the second environmental sensor 21, are the same as each other, may refer to a fact that the physical quantities in relation to the environment of the measurement target 502 are the same.

The fact that the measurement target 502 of which the environmental measurement value Ve2 is measured by the first environmental sensor 11, and the measurement target 502 of which the environmental measurement value Ve2 is measured by the second environmental sensor 21, are the same as each other, may refer to a fact that the first environmental sensor 11 and the second environmental sensor 21 shares the same space (in the present example, the interior space 508 (refer to FIG. 1)). The same space may refer to at least one of a case where the temperature or the humidity is the same in the space; a case where an ID of a short range wireless (wifi (registered trademark) or the like) communication is the same; or a case where, when the first sensor device 100 and the second sensor device 200 are mobile terminals, amplitudes and frequencies of sound waves acquired by the mobile terminals are the same as each other.

Calibration reliability of the first sensor device 100 is set as the calibration reliability R1. Reliability information in relation to the calibration reliability R1 is set as reliability information Ir1. The reliability information Ir1 is information indicating reliability of the calibration performed on the first sensor device 100, when the first sensor device 100 is calibrated. The reliability information Ir1 may include at least one of information of an elapsed time since the most recent calibration; information of a time when the calibration is performed; information of an elapsed time since the first environmental sensor 11 was installed; information of calibration means; information in relation to a variety of calibration sources; information of the number of times of the calibrations; information of a calibration frequency; information of the gas concentration at a time of the calibration; information of the NOₓ (nitrogen oxide) concentration at the time of the calibration; information of the SOₓ (sulfur oxide) concentration, or information of the PM (Particle Matter) concentration; environmental information at the time of the calibration; or information of the environmental measurement value Ve1 or the environmental measurement value Ve2 at the time of the calibration. The calibration reliability R1 may be the same as the reliability information Ir1.

As the elapsed period of time from the most recent calibration is shorter, the calibration reliability R1 is more likely to be increased. The reliability information Ir1 may be stored in the storage unit 112.

The information of the calibration means is information regarding whether the first sensor device 100 performs the self-calibration, or is calibrated by another sensor (for example, the environmental sensor 600 (refer to FIG. 1)). When the first sensor device 100 is calibrated by the other sensor, the information of the calibration means may include at least one of a distance between the first environmental sensor 11 and the other sensor, or a calibration state of the other sensor. It should be noted that the first sensor device 100 may perform the self-calibration on the first environmental sensor 11 by the calibration unit 14 calibrating the output of the first environmental sensor 11.

The information in relation to the variety of calibration sources may include at least one of the number of sensors of a calibration source of the first environmental sensor 11 (for example, the environmental sensor 600 (refer to FIG. 1)) or the number of specifications of the sensor of the calibration source. The specification of the sensor is, for example, a specific configuration of the sensor. When the first sensor device 100 performs the self-calibration, the first environmental sensor 11 may also be included in the number of the sensors of the calibration source and the number of the specifications of the sensor of the calibration source. As the number of sensors of the calibration source is higher, the calibration reliability R1 is more likely to be increased. As the number of specifications of the sensor of the calibration source is higher, the calibration reliability R1 is more likely to be increased.

The information of the number of times of the calibrations is information in relation to the number of times the first sensor device 100 has been calibrated, from a predetermined point in time in the past, to the present. The number of times of the calibrations may include the number of times of the calibrations in the case where the first sensor device 100 performs the self-calibration and in the case where the first sensor device 100 is calibrated by another sensor. As the number of times of the calibrations is higher, the calibration reliability R1 is more likely to be increased.

The information of the calibration frequency is information of the number of times of the calibrations of the first sensor device 100 per predetermined time. The number of times of the calibrations may include the number of times of the calibrations in the case where the first sensor device 100 performs the self-calibration and in the case where the first sensor device 100 is calibrated by another sensor. As the calibration frequency is higher, the calibration reliability R1 is more likely to be increased.

The information of the gas concentration at the time of the calibration is information of the gas concentration at the time of the calibration of the first sensor device 100 in a case where the first environmental sensor 11 is the gas sensor. The information of the NOₓ (nitrogen oxide) concentration at the time of the calibration is information of the NOₓ (nitrogen oxide) concentration at the time of the calibration of the first sensor device 100 in a case where the first environmental sensor 11 is the NOₓ (nitrogen oxide) sensor. The same applies to the information of the SOₓ (sulfur oxide) concentration and the information of the PM (particle matter) concentration at the time of the calibration.

The time of the calibration of the first sensor device 100 may include the time of the self-calibration of the first sensor device 100 and the time of the calibration by another sensor. In the case where the first environmental sensor 11 is the gas sensor, when the first sensor device 100 is calibrated at a time of measuring the gas concentration that is not within a predetermined range (for example, an abnormal value of the gas concentration), the calibration reliability R1 easily becomes lower than when the first sensor device 100 is calibrated at a time of measuring a gas concentration of a standard value. The same applies to a case where the first environmental sensor 11 is the NOₓ (nitrogen oxide) sensor, the SOₓ (sulfur oxide) sensor, or the PM sensor.

The environmental information at the time of the calibration may include the temperature, the humidity, or the atmospheric pressure of the space in which the first environmental sensor 11 is arranged (for example, the measurement target 501 (refer to FIG. 1)) at the time of the calibration of the first sensor device 100. When the first environmental sensor 11 is calibrated at the temperature (for example, the abnormal value of the temperature), the humidity (for example, the abnormal value of the humidity), or the atmospheric pressure (for example, the abnormal value of the atmospheric pressure) that is not within a predetermined range, the calibration reliability R1 easily becomes lower than when the first environmental sensor 11 is calibrated at a temperature, a standard humidity, or an atmospheric pressure of a standard value.

In the case where the first environmental sensor 11 is the temperature sensor, the information of the environmental measurement value Ve1 or the environmental measurement value Ve2 at the time of the calibration is temperature information at the time of the calibration of the first sensor device 100. In the case where the first environmental sensor 11 is the temperature sensor, when the first sensor device 100 is calibrated at a time of measuring a temperature that is not within a predetermined range (for example, the abnormal value of the temperature), the calibration reliability R1 easily becomes lower than when the first sensor device 100 is calibrated at a temperature of a standard value. The same applies to a case where the first environmental sensor 11 is the humidity sensor or the pressure sensor.

The calibration information transmission unit 13 may further transmit the calibration reliability R1 or the reliability information Ir1. The receiving unit 20 of the second sensor device 200 may further receive the calibration reliability R1 or the reliability information Ir1. The calibration unit 24 may calibrate the environmental measurement value Ve2 based on the first calibration information Ic′, according to the calibration reliability R1 or the reliability information Ir1.

The calibration reliability of the second sensor device 200 is set as calibration reliability R2. The reliability information in relation to the calibration reliability R2 is set as reliability information Ir2. The reliability information Ir2 is information indicating the reliability of the calibration performed on the second sensor device 200, when the second sensor device 200 is calibrated. The reliability information Ir2 may include information similar to the reliability information Ir1 described above. The calibration reliability R2 may be the same as the reliability information Ir2. The reliability information Ir2, and the reliability information Ir1 which has been received by the receiving unit 20 may be stored in the storage unit 122.

The calibration unit 24 may compare the calibration reliability R1 received by the receiving unit 20, with the calibration reliability R2 of the second sensor device 200. When the calibration reliability R1 is higher than the calibration reliability R2, the calibration unit 24 may calibrate the environmental measurement value Ve2 that is measured by the second environmental sensor 21 based on the first calibration information Ic′ received by the receiving unit 20. When the calibration reliability R1 is lower than or equal to the calibration reliability R2, the calibration unit 24 may not calibrate the environmental measurement value Ve2 that is measured by the second environmental sensor 21, and may calibrate the environmental measurement value Ve2 based on the second calibration information Ic″.

The calibration reliability R1 or the reliability information Ir1 received by the receiving unit 20 may be stored in the storage unit 122. The calibration reliability R1 or the reliability information Ir1 stored in the storage unit 122 may refer to the past calibration reliability R1 or the past reliability information Ir1 of the first sensor device 100, respectively. The calibration unit 24 may compare the calibration reliability R1 stored in the storage unit 122, with the current calibration reliability R1 of the first sensor device 100 received by the receiving unit 20. When the current calibration reliability R1 of the first sensor device 100 is higher than the calibration reliability R1 of the first sensor device 100 stored in the storage unit 122, the calibration unit 24 may calibrate the environmental measurement value Ve2 that is measured by the second environmental sensor 21 based on the first calibration information Ic′.

The calibration reliability serving as a standard for calibrating the environmental measurement value Ve2 that is measured by the second environmental sensor 21, is set as a standard calibration reliability Cs. Standard reliability information indicating the standard calibration reliability Cs is set as standard reliability information Irs. The standard calibration reliability Cs may be at least one of the calibration reliability R1 or the calibration reliability R2. When the calibration reliability R1 that is received by the receiving unit 20 is higher than the standard calibration reliability Cs, the calibration unit 24 may calibrate the environmental measurement value Ve2 that is measured by the second environmental sensor 21 based on the first calibration information Ic′.

The storage unit 122 may store the standard reliability information Irs. When the calibration reliability R1 received by the receiving unit 20 is higher than the standard calibration reliability Cs, the storage unit 122 may update the standard calibration reliability Cs based on the received calibration reliability R1, and store the updated standard calibration reliability Cs. The calibration unit 24 may calibrate the environmental measurement value Ve2 that is measured by the second environmental sensor 21 based on the first calibration information Ic′, according to the updated standard calibration reliability Cs.

When the calibration reliability R1 received by the receiving unit 20 is higher than the standard calibration reliability Cs, the storage unit 122 may update the standard calibration reliability Cs to the calibration reliability R1, and store the updated standard calibration reliability Cs. When the calibration reliability R1 is lower than the standard calibration reliability Cs, a configuration may be adopted where the storage unit 122 does not update the standard calibration reliability Cs.

The standard reliability information Irs that is stored in the storage unit 122 may be the standard reliability information Irs updated based on the calibration reliability R1, or may be the calibration reliability R2. The calibration reliability R2 may include the calibration reliability R2 of the self-calibration of the second sensor device 200, and the calibration reliability R2 when the second sensor device 200 is calibrated by another sensor.

The providing unit 22 may provide at least one of the calibration reliability R1, the calibration reliability R2, or the standard calibration reliability Cs. The providing unit 22 may provide at least one of the calibration reliability R1, the calibration reliability R2, or the standard calibration reliability Cs, while the calibration unit 24 is calibrating the environmental measurement value Ve2. The providing unit 22 may provide at least one of the calibration reliability R1, the calibration reliability R2, or the standard calibration reliability Cs, after the calibration unit 24 completes the calibration of the environmental measurement value Ve2.

A signal for performing a control on the second sensor device 200 in accordance with the calibration reliability R1 or the reliability information Ir1 is set as a first control signal S1. The storage unit 112 may store a correlation between the environmental measurement value Ve1 calculated by the computation unit 110 and the first control signal S1. The correlation Cr may include the correlation between the environmental measurement value Ve1 and the first control signal S1. The computation unit 110 may compute the first control signal S1, based on the calibration information Ic received by the receiving unit 10 and the correlation Cr stored in the storage unit 112.

The second sensor device 200 may be controlled in accordance with the calibration reliability R1 or the reliability information Ir1. The calibration information transmission unit 13 may transmit the first control signal S1 to the second sensor device 200. The receiving unit 20 may receive the first control signal S1. The second sensor device 200 may be the mobile terminal. The providing unit 22 may provide the information in accordance with the calibration reliability R1. When the providing unit 22 is the vibration providing unit, the information in accordance with the calibration reliability R1 refers to vibration information in relation to the second sensor device 200. The providing unit 22 may vibrate the second sensor device 200 based on the first control signal S1. As the calibration reliability R1 is higher, the providing unit 22 may vibrate the second sensor device 200 more strongly.

When the providing unit 22 is the display, the information in accordance with the calibration reliability R1 refers to information that is displayed on the display. The providing unit 22 may display the reliability information Ir1 indicating the calibration reliability R1. When the providing unit 22 is the speaker, the information in accordance with the calibration reliability R1 refers to audio information that is output from the speaker. The providing unit 22 may provide an audio in relation to the reliability information Ir1.

A signal for performing a control on the first sensor device 100 in accordance with the reward Rw is set as a second control signal S2. The storage unit 122 may store a correlation between the environmental measurement value Ve2 calculated by the computation unit 120 and the second control signal S2. The correlation Cr′ may include the correlation between the environmental measurement value Ve2 and the second control signal S2. The computation unit 120 may compute the second control signal S2, based on the first calibration information Ic′ received by the receiving unit 20 and the correlation Cr′ stored in the storage unit 122. The reward transmission unit 23 may transmit the second control signal S2.

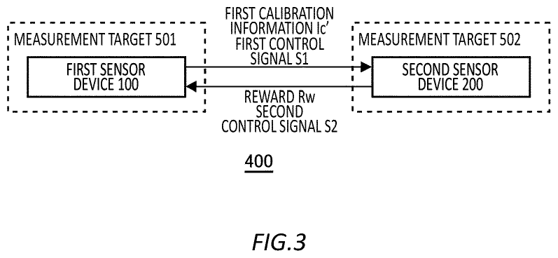

FIG. 3 is a diagram showing an example of a relationship between the first sensor device 100 and the measurement target 502 in the sensor system 400. In the present example, the calibration information transmission unit 13 (refer to FIG. 2) of the first sensor device 100 transmits the first calibration information Ic′ to the second sensor device 200, and the reward transmission unit 23 of the second sensor device 200 transmits the reward Rw to the first sensor device 100.

The calibration information transmission unit 13 (refer to FIG. 2) may transmit the first control signal S1 to the second sensor device 200. The reward transmission unit 23 (refer to FIG. 2) may transmit the second control signal S2 to the first sensor device 100. The receiving unit 10 (refer to FIG. 2) may receive the second control signal S2.

The first sensor device 100 may be the mobile terminal. The providing unit 12 (refer to FIG. 2) may provide the information in relation to the reward Rw. When the providing unit 12 is the vibration providing unit, the information in relation to the reward Rw refers to vibration information in relation to the first sensor device 100. The providing unit 12 may vibrate the first sensor device 100 based on the second control signal S2. The second control signal S2 may be a control signal in accordance with the calibration reliability R1. When the providing unit 12 is the display, the information in relation to the reward Rw refers to information that is displayed on the display. The providing unit 12 may display, on the display, the reliability information Ir1 in accordance with the calibration reliability R1. When the providing unit 12 is the speaker, the information in relation to the reward Rw refers to audio information that is output from the speaker. The providing unit 12 may provide an audio in relation to the reliability information Ir1.

As the calibration reliability R1 is higher, the providing unit 12 (refer to FIG. 2) may vibrate the first sensor device 100 more strongly. This makes it possible for the living body 90 (refer to FIG. 1) to recognize a degree of the contribution of the calibration to the second environmental sensor 21. The reward transmission unit 23 (refer to FIG. 2) may transmit, to the first sensor device 100, the reward Rw in accordance with the calibration reliability R1 or the reliability information Ir1. As the calibration reliability R1 is higher, the reward transmission unit 23 may transmit, to the first sensor device 100, the reward Rw that is higher.

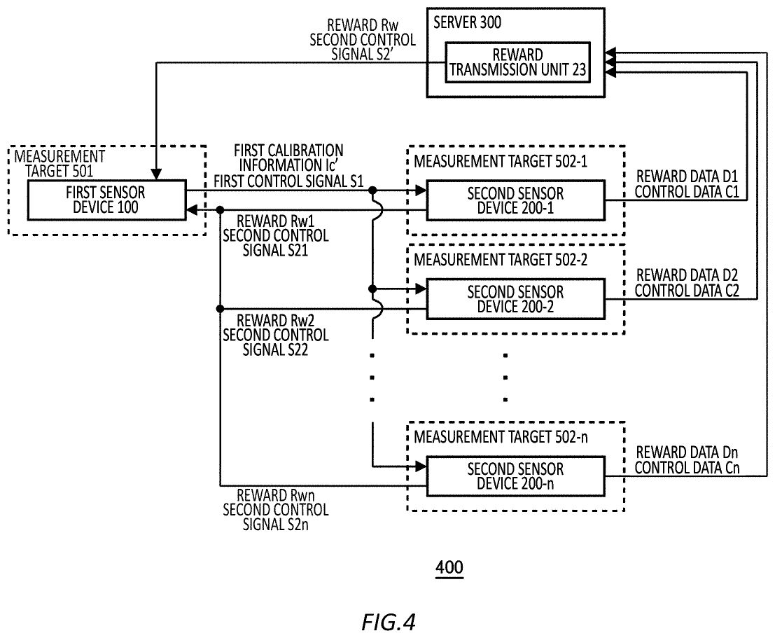

FIG. 4 is a diagram showing another example of the relationship between the first sensor device 100 and the measurement target 502 in the sensor system 400. In the present example, the sensor system 400 includes a server 300 and a plurality of second sensor devices 200 (a second sensor device 200-1 to a second sensor device 200-n). In the present example, the server 300 includes the reward transmission unit 23. In the present example, the second sensor device 200 is arranged in each of a plurality of measurement targets 502 (a measurement target 502-1 to a measurement target 502-n).

When the measurement target 502 is the store, the plurality of measurement targets 502 are, for example, a plurality of stores belonging to the same corporation. The plurality of stores are, for example, chain stores, branch stores, and the like. The server 300 is, for example, a data center server of a corporation to which the measurement target 502 belongs.

The reward transmission units 23 of the plurality of second sensor devices 200 may respectively transmit a reward Rw1 to a reward Rwn. The reward transmission units 23 of the plurality of second sensor devices 200 may respectively transmit, to the server 300, reward data D1 in relation to the reward Rw1 to reward data Dn in relation to the reward Rwn. The server 300 may generate the reward Rw based on the reward data D1 to the reward data Dn. The reward transmission unit 23 of the server 300 may transmit the reward Rw to the first sensor device 100. The reward transmission units 23 of the plurality of second sensor devices 200 may respectively transmit, to the first sensor device 100, the reward Rw1 to the Reward Rwn.

The calibration information transmission unit 13 (refer to FIG. 2) may transmit the first control signal S1 to each of the plurality of second sensor devices 200. Each of the reward transmission units 23 (refer to FIG. 2) in the plurality of second sensor devices 200 may transmit the second control signal S2 to the first sensor device 100. In the present example, the second sensor device 200-1 to the second sensor device 200-n respectively transmit a second control signal S21 to a second control signal S2n. In the present example, the receiving unit 10 (refer to FIG. 2) receives the second control signal S21 to the second control signal S2n.

The first sensor device 100 may be the mobile terminal. When the providing unit 12 (refer to FIG. 2) is the vibration providing unit, the providing unit 12 may vibrate the first sensor device 100 based on the second control signal S2. The second control signal S2 may be a control signal in accordance with the calibration reliability R1. The providing unit 12 may vibrate the first sensor device 100 based on the second control signal S2 in accordance with the highest calibration reliability R1 among the second control signal S21 to the second control signal S2n.

The reward transmission units 23 of the plurality of second sensor devices 200 may respectively transmit, to the server 300, control data C1 to control data Cn. The control data C1 to the control data Cn are control data C in relation to the reward Rw1 to the reward Rwn, respectively. The reward transmission units 23 of the plurality of second sensor devices 200 may respectively transmit, over a predetermined period, the control data C1 to the control data Cn. The transmitting over a predetermined period may mean transmitting multiple times within the period, and may not mean transmitting continuously over the period. The predetermined period is, for example, one month, half a year, one year, or the like. When the measurement target 502 is the store and the predetermined period is one year, the transmitting for one year means that the living body 90 visits the store multiple times during the one year, and transmits the control data C each time the living body 90 visits the store.

The server 300 may generate a second control signal S2′ based on the control data C1 to the control data Cn. The server 300 may receive the control data C1 to the control data Cn over a predetermined period. The server 300 may generate the second control signal S2′ based on the control data C1 to the control data Cn over the predetermined period.

The providing unit 12 (refer to FIG. 2) may vibrate the first sensor device 100 based on the second control signal S2′. The second control signal S2′ may be a control signal in accordance with the calibration reliability R1. This makes it possible for the living body 90 (refer to FIG. 1) to recognize the degree of the contribution of the calibration to the second environmental sensor 21 in each of the plurality of second sensor devices 200. The reward transmission unit 23 of the server 300 may transmit, to the first sensor device 100, the reward Rw in accordance with the calibration reliability R1. As the calibration reliability R1 is higher, the reward transmission unit 23 of the server 300 may transmit, to the first sensor device 100, the reward Rw that is higher.

The receiving unit 10 (refer to FIG. 2) of the first sensor device 100 may receive at least one of the second control signal S2 or the second control signal S2′. The receiving unit 10 may receive the second control signal S2 and the second control signal S2′ at different timings.

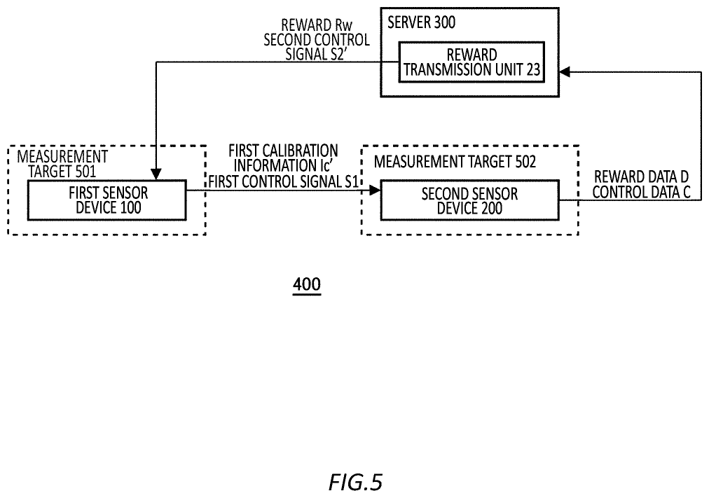

FIG. 5 is a diagram showing another example of the relationship between the first sensor device 100 and the measurement target 502 in the sensor system 400. In the present example, the sensor system 400 includes a server 310 and the second sensor device 200. In the present example, the server 310 includes the reward transmission unit 23.

When the measurement target 502 belongs to one corporation or the like, the server 310 may belong to another corporation or the like that is different from the one corporation or the like. The other corporation may be a service organization or the like that specializes in collecting reward data D and granting the reward Rw.

In the present example, the reward transmission unit 23 of the second sensor device 200 transmits, to the server 310, the reward data D and the control data C in relation to the reward Rw. In the present example, the reward transmission unit 23 of the second sensor device 200 does not transmit the reward Rw and the second control signal S2 to the first sensor device 100. In the present example, the server 310 generates the reward Rw based on the reward data D1, and generates the second control signal S2′ based on the control data C. In the present example, the reward transmission unit 23 of the server 310 transmits the reward Rw and the second control signal S2′ to the first sensor device 100.

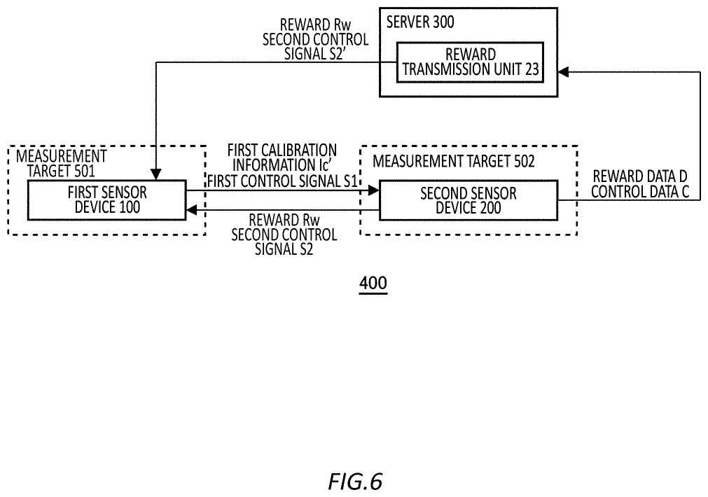

FIG. 6 is a diagram showing another example of the relationship between the first sensor device 100 and the measurement target 502 in the sensor system 400. In the present example, the reward transmission unit 23 of the second sensor device 200 and the reward transmission unit 23 of the server 310 transmit the reward Rw to the first sensor device 100. In the present example, the reward transmission unit 23 of the second sensor device 200 transmits the second control signal S2 to the first sensor device 100, and the reward transmission unit 23 of the server 310 transmits the second control signal S2′ to the first sensor device 100. In this respect, the sensor system 400 of the present example is different from the sensor system 400 which is shown in FIG. 5. The reward Rw may be transmitted by one of the reward transmission unit 23 of the second sensor device 200 and the reward transmission unit 23 of the server 310. One of the second control signal S2 and the second control signal S2′ may be transmitted to the first sensor device 100.

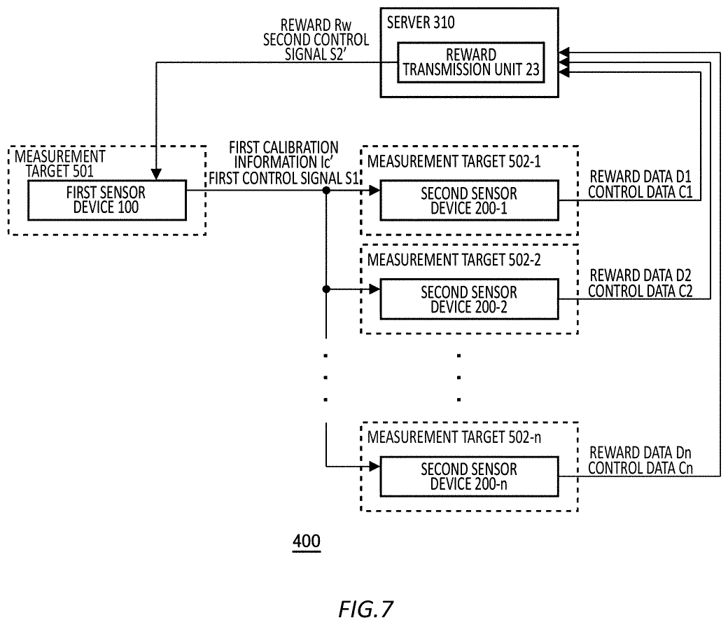

FIG. 7 is a diagram showing another example of the relationship between the first sensor device 100 and the measurement target 502 in the sensor system 400. In the present example, the sensor system 400 includes the server 310 and the plurality of second sensor devices 200 (the second sensor device 200-1 to the second sensor device 200-n). In the present example, the server 310 includes the reward transmission unit 23. In the present example, the second sensor device 200 is arranged in each of a plurality of measurement targets 502 (the measurement target 502-1 to the measurement target 502-n).

When the measurement target 502 is the store, the plurality of measurement targets 502 are, for example, a plurality of stores belonging to the same corporation or the like. The plurality of stores are, for example, chain stores, branch stores, and the like. When the measurement target 502 belongs to one corporation or the like, the server 310 may belong to another corporation or the like that is different from the one corporation or the like.

In the present example, the reward transmission units 23 of the plurality of second sensor devices 200 respectively transmit, to the server 310, the reward data D1 to the reward data Dn and the control data C1 to the control data Cn. In the present example, the server 310 generates the reward Rw based on the reward data D1 to the reward data Dn, and generates the second control signal S2′ based on the control data C1 to the control data Cn. In the present example, the reward transmission unit 23 of the server 310 transmits the reward Rw and the second control signal S2′ to the first sensor device 100. In the present example, the respective reward transmission units 23 of the plurality of second sensor devices 200 do not transmit, to the first sensor device 100, the reward Rw1 to the reward Rwn and the control data C1 to the control data Cn.

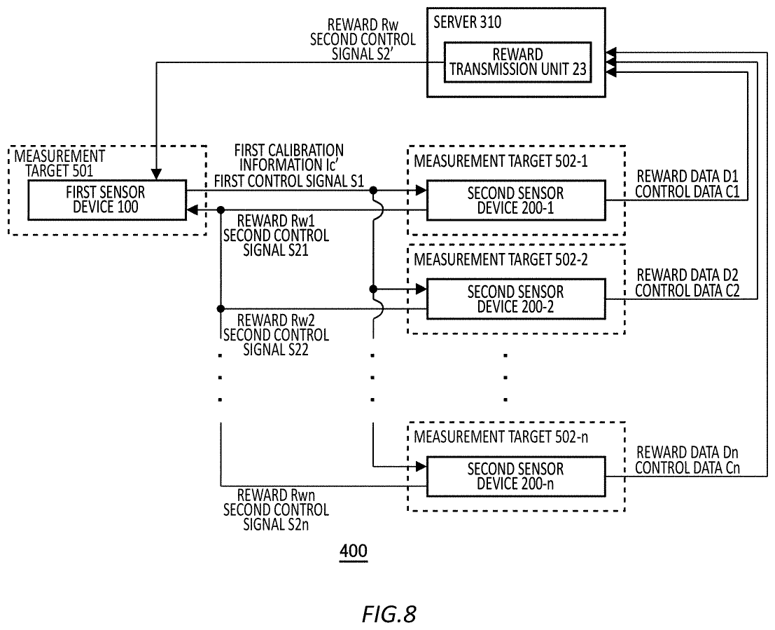

FIG. 8 is a diagram showing another example of the relationship between the first sensor device 100 and the measurement target 502 in the sensor system 400. In the present example, the respective reward transmission units 23 in the plurality of second sensor devices 200 and the reward transmission unit 23 of the server 310 transmit, to the first sensor device 100, the reward Rw1 to the reward Rwn. In the present example, the reward transmission units 23 of the plurality of second sensor devices 200 respectively transmit, to the first sensor device 100, the second control signal S21 to the second control signal S2n; and the reward transmission unit 23 of the server 310 transmits the second control signal S2′ to the first sensor device 100. In this respect, the sensor system 400 of the present example is different from the sensor system 400 which is shown in FIG. 7. The reward transmission unit 23 of the second sensor device 200 may transmit the reward Rw1 to the reward Rwn, or the reward transmission unit 23 of the server 310 may transmit the reward Rw. The reward transmission unit 23 of the second sensor device 200 may transmit the second control signal S21 to the second control signal S2n, or the reward transmission unit 23 of the server 310 may transmit the second control signal S2′.

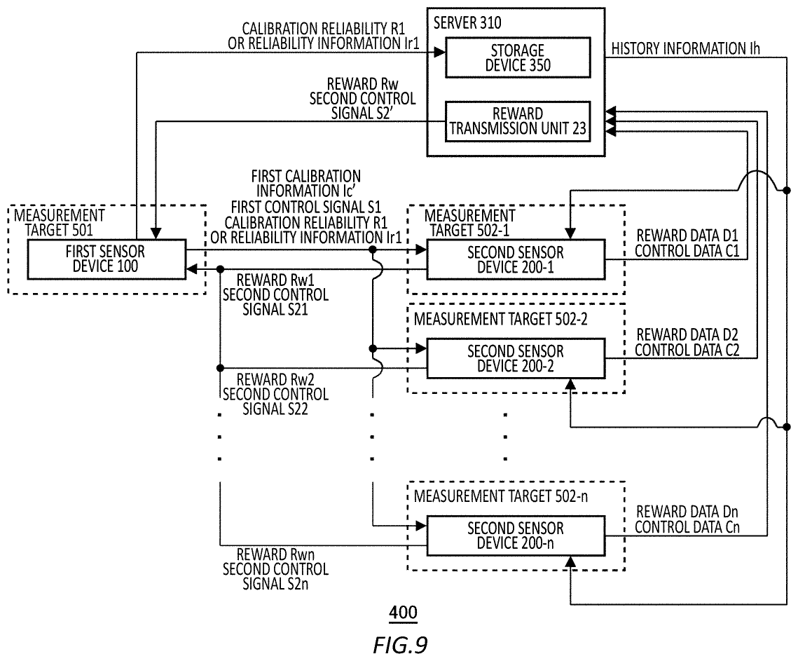

FIG. 9 is a diagram showing another example of the relationship between the first sensor device 100 and the measurement target 502 in the sensor system 400. In the present example, the sensor system 400 further includes a storage device 350. In the present example, the calibration information transmission unit 13 (refer to FIG. 2) of the first sensor device 100 transmits the reliability information Ir1 to the second sensor device 200 and the storage device 350. In this respect, the sensor system 400 of the present example is different from the sensor system 400 which is shown in FIG. 8.

In the present example, the storage device 350 is included in the server 310. The storage device 350 stores the reliability information Ir1. The storage device 350 may store the first calibration information Ic′ and the reliability information Ir1.

The calibration information transmission unit 13 (refer to FIG. 2) may transmit the reliability information Ir1 and the first calibration information Ic′ over a predetermined period. The transmitting over a predetermined period may mean transmitting multiple times within the period, and may not mean transmitting continuously over the period. The predetermined period is, for example, one month, half a year, one year, or the like. When the measurement target 502 is the store and the predetermined period is one year, the transmitting for one year means that the living body 90 visits the store multiple times during the one year, and transmits the reliability information Ir1 and the first calibration information Ic′ each time the living body 90 visits the store. The storage device 350 may store the reliability information Ir1 and first calibration information Ic′ over the predetermined period.

When the server 310 includes the storage device 350, the calibration information transmission unit 13 (refer to FIG. 2) may transmit the reliability information Ir1 to the second sensor device 200, and may not transmit the reliability information Ir1 to the storage device 350. When the calibration information transmission unit 13 does not transmit the reliability information Ir1 to the storage device 350, the receiving unit 20 (refer to FIG. 2) of the second sensor device 200 may receive the reliability information Ir1, and the reward transmission unit 23 (refer to FIG. 2) of the second sensor device 200 may transmit the received reliability information Ir1 to the storage device 350.

The reward transmission unit 23 of the server 310 may transmit the reward Rw based on a history of the calibration reliability R1 or the reliability information Ir1 stored in the storage device 350. The reward transmission unit 23 of the server 310 may not transmit the reward Rw. When the reward transmission unit 23 of the server 310 does not transmit the reward Rw, the server 310 may transmit, to the second sensor device 200, history information Ih in relation to the history of the calibration reliability R1 or the reliability information Ir1.The receiving unit 20 (refer to FIG. 2) may receive the history information Ih, and the reward transmission unit 23 (refer to FIG. 2) of the second sensor device 200 may transmit the reward R2 based on the history information Ih.

The history of the calibration reliability R1 or the reliability information Ir1 may be the history of the calibration reliability R1 or the reliability information Ir1 over a predetermined period, which is stored in the storage device 350. The reward transmission unit 23 may transmit, to the first sensor device 100, the reward Rw in accordance with the history of the calibration reliability R1 or the reliability information Ir1. As the calibration reliability R1 over a predetermined period is higher, the reward transmission unit 23 may transmit the reward Rw that is higher. This makes it possible for the living body 90 (refer to FIG. 1) who has the first sensor device 100 to obtain the reward Rw in accordance with the degree of the contribution of the calibration to the second environmental sensor 21.

The storage device 350 may be included in the second sensor device 200. When the storage device 350 is included in the second sensor device 200, the storage device 350 may be the storage unit 122 of the second sensor device 200 (refer to FIG. 2). The storage device 350 may be a cloud. That is, the reliability information Ir1 and the first calibration information Ic′ may be stored in the cloud.

When the measurement target 502 is the store, the reliability information Ir1 may include the number of times that the living body 90 (refer to FIG. 1) uses the store, the frequency of use, and an amount of money spent at the store. When the plurality of measurement targets 502 are a plurality of stores belonging to the same corporation or the like, the reliability information Ir1 may include the number of times that one or more stores are used among the plurality of stores. The reward transmission unit 23 may transmit the reward Rw based on the reliability information Ir1.

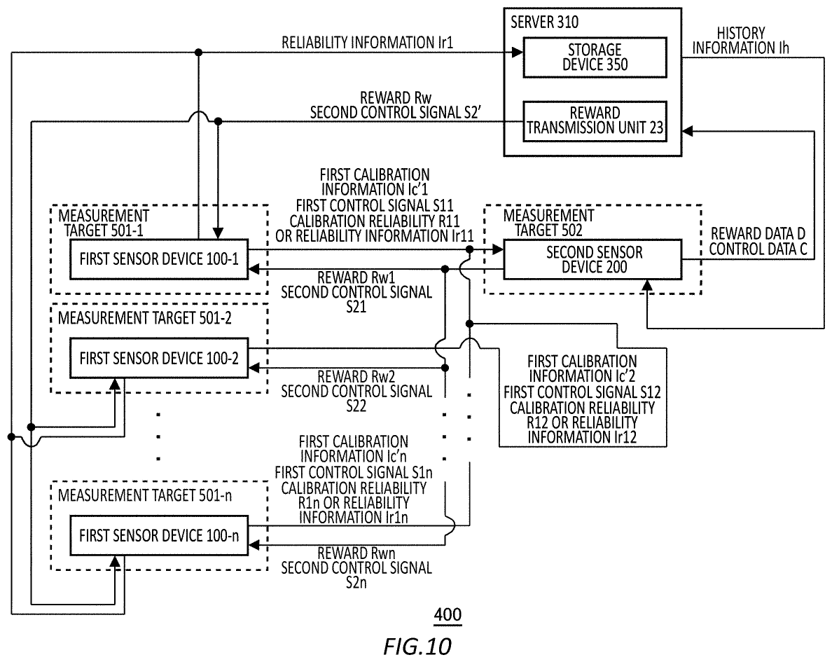

FIG. 10 is a diagram showing another example of the relationship between the first sensor device 100 and the measurement target 502 in the sensor system 400. In the present example, the sensor system 400 includes a plurality of first sensor devices 100 (a first sensor device 100-1 to a first sensor device 100-n). In the present example, the sensor system 400 includes the storage device 350. In this respect, the sensor system 400 of the present example is different from the sensor system 400 which is shown in FIG. 6.

In the present example, the first sensor device 100 is arranged in each of a plurality of measurement targets 501 (a measurement target 501-1 to a measurement target 501-n). The plurality of first sensor devices 100 may be arranged on one measurement target 501.

Each of the calibration information transmission units 13 (refer to FIG. 2) in the plurality of first sensor devices 100 may transmit the first calibration information Ic′ and the reliability information Ir1 of each of the first sensor devices 100. The first calibration information Ic′ of the first sensor device 100-1 to the first calibration information Ic′ of the first sensor device 100-n are set as first calibration information Ic′1 to first calibration information Ic′n, respectively. The calibration reliability R1 of the first sensor device 100-1 to the calibration reliability R1 of the first sensor device 100-n are set as calibration reliability R11 to calibration reliability R1n, respectively. The reliability information Ir1 of the first sensor device 100-1 to the reliability information Ir1 of the first sensor device 100-n are set as reliability information Ir11 to reliability information Ir1n, respectively. In the present example, the calibration information transmission units 13 of the first sensor device 100-1 to the first sensor device 100-n respectively transmits the first calibration information Ic′1 to the first calibration information Ic′n, and respectively transmits the calibration reliability R11 to the calibration reliability R1n or the reliability information Ir11 to the reliability information Ir1n.

The storage device 350 may store the calibration reliability R11 to the calibration reliability R1n or the reliability information Ir11 to the reliability information Ir1n that are transmitted by the calibration information transmission unit 13 (refer to FIG. 2). The storage device 350 may further store the first calibration information Ic′1 to the first calibration information Ic′n that are transmitted by the calibration information transmission unit 13 (refer to FIG. 2). The storage device 350 may associate one first sensor device 100, and the calibration reliability R1 or the reliability information Ir1 and the first calibration information Ic′ that are transmitted by the one first sensor device 100, for storing.

A predetermined threshold value of the calibration reliability R1 of the first sensor device 100 is set as a threshold value Rth. When the calibration reliability R1 exceeds the threshold value Rth, a user of the second sensor device 200 can trust the first calibration information Ic′ in relation to the calibration reliability R1.

The reward transmission unit 23 may transmit the information indicating that the first calibration information Ic′ is desired to be transmitted, to the first sensor device 100 which has transmitted the reliability information Ir1 exceeding the threshold value Rth, in the history of the calibration reliability R1 or the reliability information Ir1 stored in the storage device 350. The information may be included in the second control signal S2. When the measurement target 502 is the store, the store can calibrate the second environmental sensor 21 (refer to FIG. 2) by the first calibration information Ic′ that is reliable.

The receiving unit 20 (refer to FIG. 2) of the second sensor device 200 may receive the first calibration information Ic′, and the calibration reliability R1 or the reliability information Ir1 of each of the plurality of first sensor devices 100. The calibration unit 24 (refer to FIG. 2) may weight the first calibration information Ic′ in each of the plurality of first sensor devices 100 according to the calibration reliability R1. The calibration unit 24 (refer to FIG. 2) may calibrate the environmental measurement value Ve2 that is measured by the second environmental sensor 21 (refer to FIG. 2) according to the weighting of the first calibration information Ic′1 to the first calibration information Ic′n.

The weighting of the first calibration information Ic′ according to the calibration reliability R1 means that the weighting of the first calibration information Ic′ according to the calibration reliability R1 with high reliability is set to be greater than the weighting of the first calibration information Ic′ according to the calibration reliability R1 with low reliability. For example, when the sensor system 400 includes three first sensor devices 100, and the calibration reliability R1 of the first sensor device 100-1 to the calibration reliability R1 of the first sensor device 100-3 are high, medium, and low, respectively, each weighting of the calibration reliability R1 refers to weighting of the first calibration information Ic′1 to the first calibration information Ic′3, for example, by 80%, 50%, and 20%, respectively. The calibration unit 24 may: set, by 100%, the weighting of the first calibration information Ic′ with the highest calibration reliability R1; and set, by 0%, the weighting of the first calibration information Ic′ with the calibration reliability R1 that is lower than or equal to a predetermined value.

The reward transmission unit 23 of the second sensor device 200 (refer to FIG. 2) or the reward transmission unit 23 of the server 310 may transmit the reward Rw in accordance with the calibration reliability R1. In the present example, the reward transmission unit 23 of the second sensor device 200 or the reward transmission unit 23 of the server 310 transmits, to each of the plurality of first sensor devices 100, the reward Rw in accordance with the calibration reliability R1. The reward transmission unit 23 may transmit the reward Rw that is higher, to the first sensor device 100 which has transmitted the first calibration information Ic′ with the calibration reliability R1 that is higher. The reward transmission unit 23 may not transmit the reward Rw to the first sensor device 100 which has transmitted the first calibration information Ic′ with the calibration reliability R1 that is lower than the threshold value Rth. When the measurement target 502 is the store, the reward transmission unit 23 may transmit, to the first sensor device 100, advertisement information of the store instead of transmitting the reward Rw.

The reward transmission unit 23 may transmit a recommended time for the calibration unit 24 (refer to FIG. 2) to calibrate the environmental measurement value Ve2. The recommended time is set as a recommended time Tr. The reward transmission unit 23 may transmit the recommended time Tr to the first sensor device 100. When the measurement target 502 is the store, the recommended time Tr is, for example, a time when the store wants to calibrate the second environmental sensor 21 (refer to FIG. 2), or a time when the store is open during business hours but there is no customer, or the like. A start time of the recommended time Tr may be a first timing at which the reward transmission unit 23 transmits the recommended time Tr to the first sensor device 100, or may be a second timing later than the first timing. A case where the start time of the recommended time Tr is the first timing is a case where it is preferable for the environmental measurement value Ve2 to be calibrated immediately.

The receiving unit 10 (refer to FIG. 2) of the first sensor device 100 may receive the recommended time Tr. The calibration information transmission unit 13 (refer to FIG. 2) may transmit the first calibration information Ic′ at the recommended time Tr. The receiving unit 20 (refer to FIG. 2) of the second sensor device 200 may receive the first calibration information Ic′ at the recommended time Tr.

When the calibration unit 24 (refer to FIG. 2) calibrates the environmental measurement value Ve2 at the recommended time Tr, the reward transmission unit 23 may transmit the reward Rw in accordance with the calibration of the environmental measurement value Ve2 at the recommended time Tr. When the calibration unit 24 (refer to FIG. 2) calibrates the environmental measurement value Ve2 at the recommended time Tr, the environmental measurement value Ve2 can be closer to the true value than before the calibration. When the measurement target 502 is the store and the environmental measurement value Ve2 is close to the true value, a customer who has been hesitant about entering the store may enter the store. This makes it possible to increase sales at the store.

In addition to the reward Rw for the calibration by the calibration unit 24 (refer to FIG. 2), the reward transmission unit 23 may transmit the reward Rw in accordance with the calibration of the environmental measurement value Ve2 at the recommended time Tr. When the calibration unit 24 (refer to FIG. 2) calibrates the environmental measurement value Ve2 at a time other than the recommended time Tr, the reward transmission unit 23 may transmit the reward Rw for the calibration by the calibration unit 24, and may not transmit the reward Rw in accordance with the calibration of the environmental measurement value Ve2 at the recommended time Tr. When the measurement target 502 is the store, and a customer enters the store and purchases a product or a service of the store, the reward transmission unit 23 may further transmit the reward Rw in relation to the purchase of the product or the service.

When a transmission command with a message to transmit the first calibration information Ic′ is input to the first sensor device 100, the calibration information transmission unit 13 (refer to FIG. 2) may transmit the first calibration information Ic′. The transmission command is set as a transmission command Cm. The transmission command Cm may be input by the living body 90 (refer to FIG. 1) through the input unit 16 (refer to FIG. 2).

The transmission command Cm may be input at the recommended time Tr. The first calibration information Ic′ may be transmitted at the recommended time Tr. The case where the transmission command Cm is input at the recommended time Tr is, for example, a case where after the first sensor device 100 receives the recommended time Tr, the living body 90 (refer to FIG. 2) intentionally starts an application in relation to the transmission of the first calibration information Ic′, and then transmits the first calibration information Ic′.

When the receiving unit 20 (refer to FIG. 2) receives the first calibration information Ic′ based on the transmission command Cm at the recommended time Tr, the reward transmission unit 23 may transmit the reward Rw in accordance with the calibration of the environmental measurement value Ve2 at the recommended time Tr; and the reward Rw in relation to the transmission of the first calibration information Ic′ based on the transmission command Cm. The intentional starting of the application in relation to the transmission of the first calibration information Ic′ by the living body 90 (refer to FIG. 2) requires the living body 90 to take the trouble. In the present example, the reward Rw in relation to the transmission of the first calibration information Ic′ based on the transmission command Cm refers to the reward Rw in relation to this trouble.

When the receiving unit 20 (refer to FIG. 2) receives the first calibration information Ic′1 to the first calibration information Ic′n based on the transmission command Cm at the recommended time Tr, the reward Rw may be weighted in order in which the first calibration information Ic′ is received. The receiving unit 20 may receive a transmission time at which the first calibration information Ic′ is transmitted by the calibration information transmission unit 13 (refer to FIG. 2). The reward Rw may be weighted in order of the transmission time. The weighting in order of the transmission time means that the weighting of the first calibration information Ic′ with an earlier transmission time is set to be greater than the weighting of the first calibration information Ic′ with a later transmission time. The reward transmission unit 23 may transmit the weighted reward Rw. The reward transmission unit 23 may transmit the reward Rw that is higher, to the first sensor device 100 of the living body 90 who takes the trouble earlier to intentionally start the application in relation to the transmission of the first calibration information Ic′.

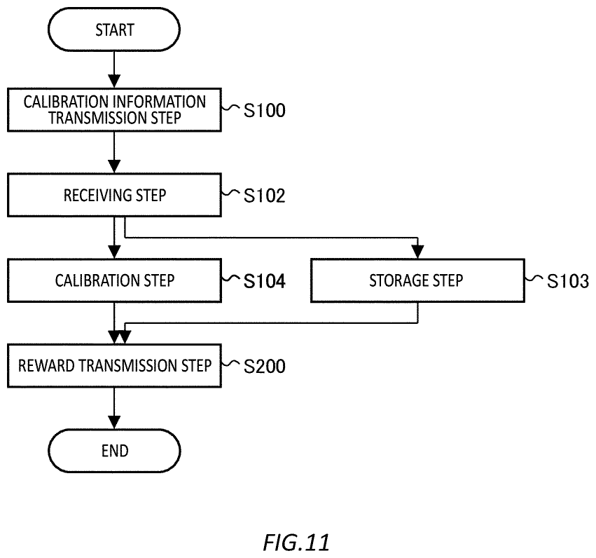

FIG. 11 is a flowchart showing an example of a method according to an embodiment of the present invention. A method according to an embodiment of the present invention will be described by using, as an example, the sensor system 400 which is shown in FIG. 2 to FIG. 10. The method includes a reward transmission step S200. The method may include a calibration information transmission step S100, a receiving step S102, a storage step S103, and a calibration step S104.

The reward transmission step S200 is a step in which the reward transmission unit 23 transmits the reward Rw. The reward Rw is a reward for calibrating the environmental measurement value Ve2 of the measurement target 502 that is measured by the second environmental sensor 21, based on the first calibration information Ic′ for calibrating the environmental measurement value Ve1 of the measurement target 501 that is measured by the first environmental sensor 11.

The calibration information transmission step S100 is a step in which the calibration information transmission unit 13 transmits the first calibration information Ic′. The receiving step S102 is a step in which the receiving unit 20 receives the first calibration information Ic′ transmitted in the calibration information transmission step S100. The calibration step S104 is a step in which the calibration unit 24 calibrates the environmental measurement value Ve2 of the measurement target 502 that is measured by the second environmental sensor 21, based on the first calibration information Ic′.

The calibration information transmission step S100 may be a step in which the calibration information transmission unit 13 transmits the first calibration information Ic′, and the calibration reliability R1 or the reliability information Ir1 of the first sensor device 100. The receiving step S102 may be a step in which the receiving unit 20 receives the first calibration information Ic′, and the calibration reliability R1 or the reliability information Ir1 transmitted in the calibration information transmission step S100. The calibration step S104 may be a step in which the calibration unit 24 calibrates the environmental measurement value Ve2 that is measured by the second environmental sensor 21, based on the first calibration information Ic′, according to the calibration reliability R1 or the reliability information Ir1 of the first sensor device 100.

The calibration information transmission step S100 may be a step in which the calibration information transmission unit 13 performs the control on the second sensor device 200 in accordance with the calibration reliability R1 or the reliability information Ir1 of the first calibration information Ic′. The calibration information transmission step S100 may be a step in which the calibration information transmission unit 13 transmits, to the second sensor device 200, the first control signal S1 for performing the control in accordance with the calibration reliability R1 or the reliability information Ir1 of the first calibration information Ic′. The reward transmission step S200 may be a step in which the reward transmission unit 23 transmits the second control signal S2 for performing the control on the first sensor device 100 in accordance with the reward Rw.

The storage step S103 is a step in which the storage device 350 stores the calibration reliability R1 or the reliability information Ir1. The reward transmission step S200 may be a step in which the reward transmission unit 23 transmits the reward Rw based on the history of the calibration reliability R1 or the reliability information Ir1 stored in the storage step S103.

The calibration information transmission step S100 may be a step in which each of the calibration information transmission unit 13 in the plurality of first sensor devices 100 transmits the first calibration information Ic′, and the calibration reliability R1 or the reliability information Ir1 of each of the first sensor devices 100. The storage step S103 may be a step in which the storage device 350 stores each of the calibration reliability R1 or the reliability information Ir1 that is transmitted in the calibration information transmission step S100. The reward transmission step 200 may be a step in which the reward transmission unit 23 may transmit the information indicating that the first calibration information Ic′ is desired to be transmitted, to the first sensor device 100 that has transmitted the reliability information Ir1 exceeding the threshold value Rth of the calibration reliability R1, in the history of the calibration reliability R1 or the reliability information Ir stored in the storage step S103.

The receiving step S102 may be a step in which the receiving unit 20 receives the first calibration information Ic′, and the calibration reliability R1 or the reliability information Ir1 in each of the plurality of first sensor devices 100. The calibration step S104 may be a step in which the calibration unit 24 weights the first calibration information Ic′ in each of the plurality of first sensor devices 100 according to the calibration reliability R1, and calibrates the environmental measurement value Ve2 according to the weighting of the first calibration information Ic′. The reward transmission step S200 may be a step in which the reward transmission unit 23 transmits the reward Rw to each of the plurality of first sensor devices 100 in accordance with the calibration reliability R1.

In the reward transmission step S200, the reward transmission unit 23 may transmit the recommended time Tr at which the calibration unit 24 calibrates the environmental measurement value Ve2. When the environmental measurement value Ve2 is calibrated at the recommended time Tr, the reward transmission step S200 may be a step in which the reward Rw is transmitted in accordance with the calibration of the environmental measurement value Ve2 at the recommended time Tr.

The calibration information transmission step 100 may be a step in which the calibration information transmission unit 13 transmits the first calibration information Ic′ when the transmission command Cm with a message to transmit the first calibration information Ic′ is input to the first sensor device 100. The reward transmission step S200 may be a step in which when the receiving unit 20 receives the first calibration information based on the transmission command Cm at the recommended time in the receiving step S102, the reward transmission unit 23 transmits the reward Rw in accordance with the calibration of the environmental measurement value Ve2 at the recommended time Tr, and the reward Rw in relation to the transmission of the first calibration information Ic′ based on the transmission command Cm. The reward transmission step S200 may be a step in which when the receiving unit 20 receives the first calibration information Ic′ of each of the plurality of first sensor devices 100 at the recommended time Tr in the receiving step 102, the reward Rw weighted in order in which the first calibration information Ic′ is received, is transmitted.

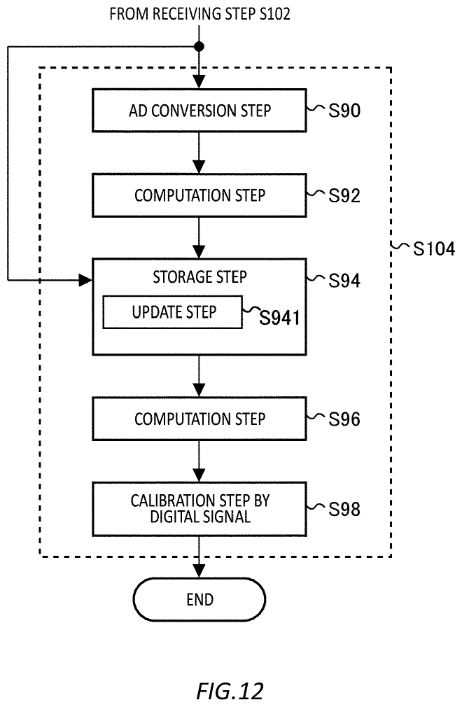

FIG. 12 shows an example of a detail of the calibration step S104 in FIG. 11. An AD conversion step S90 is a step in which the AD conversion unit 28 converts the analog signal output from the second environmental sensor 21 into the digital signal. A computation step S92 is a step in which the computation unit 120 calculates the environmental measurement value Ve2 based on the digital signal converted in the AD conversion step S90. A storage step S94 is a step in which the storage unit 112 stores the environmental measurement value Ve2 calculated in the computation step S92. The storage step S94 may be a step in which the correlation Cr′ between the environmental measurement value Ve2 calculated in the computation step S92, and the first calibration information Ic′, is stored.

A computation step S96 is a step in which the computation unit 120 computes the second calibration information Ic″, based on the first calibration information Ic′ received in the receiving step 102, and the correlation Cr′ stored in the storage step S94. A calibration step S98 by the digital signal is a step in which the calibration unit 24 (refer to FIG. 4) calibrates the environmental measurement value Ve2 by the second calibration information Ic″ of the digital signal. It should be noted that the computation step S96 may be a step in which the calibration unit 24 calculates and calibrates the environmental measurement value Ve2, based on the digital signal converted in the AD conversion step S90 and the first calibration information Ic′ received in the receiving step S102.

The storage unit 122 may store the standard reliability information Irs. When the calibration reliability R1 received in the receiving step S102 is higher than the standard calibration reliability Cs, the storage step S94 may include an update step S941 in which the storage unit 122 updates the standard calibration reliability Cs based on the received calibration reliability R1. In the storage step S94, the storage unit 122 may store the updated standard calibration reliability Cs. The calibration step S104 may be a step in which the calibration unit 24 calibrates the environmental measurement value Ve2 based on the first calibration information Ic′, according to the updated standard calibration reliability Cs.

When the calibration reliability R1 received in the receiving step S102 is higher than the standard calibration reliability Cs, the updating step S941 may be a step in which the storage unit 122 updates the standard calibration reliability Cs to the calibration reliability R1. When the calibration reliability R1 is lower than the standard calibration reliability Cs, in the storage step S94, a configuration may be adopted where the storage unit 122 does not update the standard calibration reliability Cs.

The standard reliability information Irs that is stored in the storage step S94 may be the standard reliability information Irs updated based on the calibration reliability R1, or may be the calibration reliability R2. The calibration reliability R2 may include the calibration reliability R2 of the self-calibration of the second sensor device 200, and the calibration reliability R2 when the second sensor device 200 is calibrated by another sensor.

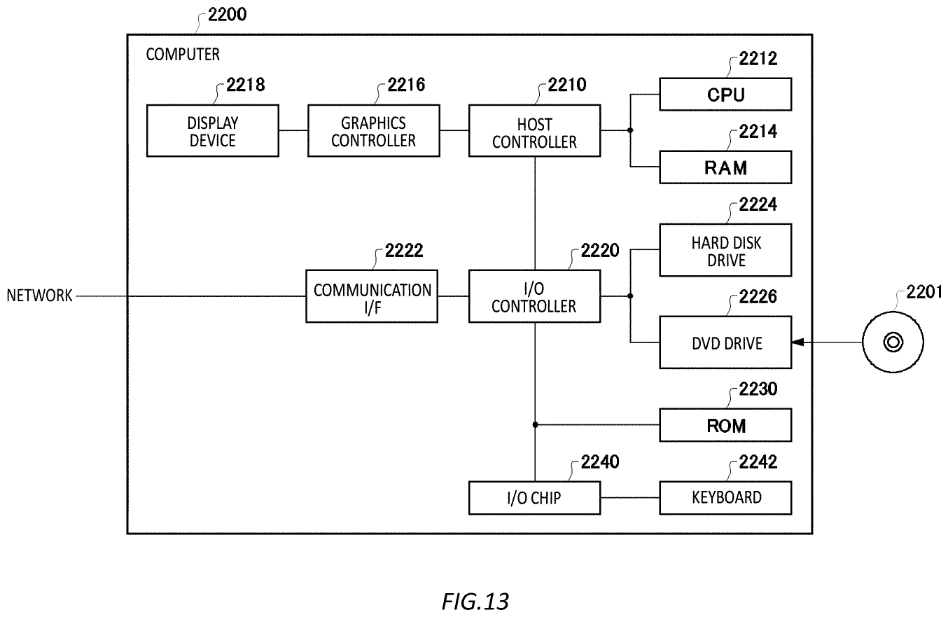

FIG. 13 is a diagram showing an example of a computer 2200 in which the sensor system 400 according to an embodiment of the present invention may be implemented in whole or in part. A program that is installed in the computer 2200 can cause the computer 2200 to function as the operation associated with the sensor system 400 according to embodiments of the present invention or as one or more sections of the sensor system 400, or can cause the computer 2200 to perform the operation or the one or more sections thereof, or can cause the computer 2200 to perform each step (refer to FIG. 11 and FIG. 12) according to a method of the present invention. The program may be performed by a CPU 2212 so as to cause the computer 2200 to perform certain operations associated with some or all of the blocks of flowcharts (FIG. 11 and FIG. 12) and block diagrams (FIG. 2 to FIG. 10) described herein.

The computer 2200 according to an embodiment of the present invention includes the CPU 2212, a RAM 2214, a graphics controller 2216, and a display device 2218. The CPU 2212, the RAM 2214, the graphics controller 2216, and the display device 2218 are mutually connected by a host controller 2210. The computer 2200 further includes input/output units such as a communication interface 2222, a hard disk drive 2224, a DVD-ROM drive 2226, and an IC card drive. The communication interface 2222, the hard disk drive 2224, the DVD-ROM drive 2226, and the IC card drive, and the like are connected to the host controller 2210 via an input/output controller 2220. The computer further includes legacy input/output units such as a ROM 2230 and a keyboard 2242. The ROM 2230, the keyboard 2242, and the like are connected to the input/output controller 2220 via an input/output chip 2240.

The CPU 2212 operates according to programs stored in the ROM 2230 and the RAM 2214, thereby controlling each unit. The graphics controller 2216 acquires image data generated by the CPU 2212 on a frame buffer or the like provided in the RAM 2214 or in the RAM 2214 itself to cause the image data to be displayed on the display device 2218.

The communication interface 2222 communicates with other electronic devices via a network. The hard disk drive 2224 stores programs and data used by the CPU 2212 in the computer 2200. The DVD-ROM drive 2226 reads the programs or the data from the DVD-ROM 2201, and provides the read programs or the data to the hard disk drive 2224 via the RAM 2214. The IC card drive reads the programs and the data from the IC card, or writes the programs and the data to the IC card.

The ROM 2230 stores a boot program or the like executed by the computer 2200 at the time of activation, or a program depending on the hardware of the computer 2200. The input/output chip 2240 may connect various input/output units via a parallel port, a serial port, a keyboard port, a mouse port, or the like to the input/output controller 2220.

The program is provided by a computer-readable medium such as the DVD-ROM 2201 or the IC card. The program is read from a computer-readable medium, installed in the hard disk drive 2224, the RAM 2214, or the ROM 2230 which are also examples of the computer-readable medium, and executed by the CPU 2212. The information processing written in these programs is read by the computer 2200 and provides cooperation between the programs and the above-described various types of hardware resources. An apparatus or a method may be constituted by realizing the operation or processing of information in accordance with the usage of the computer 2200.

For example, when a communication is executed between the computer 2200 and an external device, the CPU 2212 may execute a communication program loaded onto the RAM 2214 to instruct the communication interface 2222 to process the communication, based on the processing written in the communication program. The communication interface 2222, under control of the CPU 2212, reads transmission data stored on a transmission buffering region provided in a recording medium such as the RAM 2214, the hard disk drive 2224, the DVD-ROM 2201, or the IC card, and transmits the read transmission data to a network or writes reception data received from a network to a reception buffering region or the like provided on the recording medium.

The CPU 2212 may cause all or a necessary portion of a file or a database to be read into the RAM 2214, the file or the database having been stored in an external recording medium such as the hard disk drive 2224, the DVD-ROM drive 2226 (DVD-ROM 2201), the IC card, or the like. The CPU 2212 may execute various types of processing on the data on the RAM 2214. The CPU 2212 may then write back the processed data to the external recording medium.

Various types of information, such as various types of programs, data, tables, and databases, may be stored in the recording medium to undergo information processing. The CPU 2212 may execute various types of processing on the data read from the RAM 2214, which includes various types of operations, information processing, condition judging, conditional branch, unconditional branch, search or replacement of information, or the like, as described throughout the present disclosure and designated by an instruction sequence of programs. The CPU 2212 may write the result back to the RAM 2214.

The CPU 2212 may search for information in a file, a database, or the like in the recording medium. For example, when a plurality of entries, each having an attribute value of a first attribute associated with an attribute value of a second attribute, are stored in the recording medium, the CPU 2212 may search for an entry matching the condition whose attribute value of the first attribute is designated, from among the plurality of entries, and read the attribute value of the second attribute stored in the entry, and may obtain, by reading the attribute value of the second attribute, the attribute value of the second attribute associated with the first attribute satisfying the predetermined condition.

The program or software modules described above may be stored in the computer-readable medium on the computer 2200 or of the computer 2200. A recording medium such as a hard disk or a RAM provided in a server system connected to a dedicated communication network or the Internet can be used as the computer-readable medium. The program may be provided to the computer 2200 by the recording medium.

While the present invention has been described with the embodiments, the technical scope of the present invention is not limited to the above-described embodiments. It is apparent to persons skilled in the art that various alterations and improvements can be added to the above-described embodiments. It is also apparent from the description of the claims that embodiments added with such alterations or improvements can be included in the technical scope of the present invention.

The operations, procedures, steps, and stages of each process performed by an apparatus, system, program, and method illustrated in the claims, embodiments, or diagrams can be performed in any order as long as the order is not indicated by “prior to,” “before,” or the like and as long as the outputted from a previous process is not used in a later process. Even if the operation flow is described by using phrases such as “first” or “next” in the scope of the claims, specification, or drawings, it does not necessarily mean that the process must be performed in this order.

[Item 1] A method including reward transmitting of transmitting, by a reward transmission unit, a reward for calibrating an environmental measurement value of a measurement target that is measured by a second environmental sensor, based on first calibration information for calibrating an environmental measurement value of a measurement target that is measured by a first environmental sensor.
[Item 2] The method according to item 1, further including calibrating of calibrating, by a calibration unit, the environmental measurement value of the measurement target that is measured by the second environmental sensor, based on the first calibration information.
[Item 3] The method according to item 2, in which the measurement target of which the environmental measurement value is measured by the first environmental sensor, and the measurement target of which the environmental measurement value is measured by the second environmental sensor, are the same as each other.
[Item 4] The method according to item 3, in which the second environmental sensor is provided in a second sensor device, and

the second sensor device is arranged in an interior space, in the measurement target of which the environmental measurement value is measured by the second environmental sensor.

[Item 5] The method according to item 4, in which

the first environmental sensor is provided in a first sensor device, and

which further includes

calibration information transmitting of transmitting, by a calibration information transmission unit, the first calibration information, and calibration reliability of the first sensor device or reliability information in relation to the calibration reliability,

receiving of receiving, by a receiving unit, the first calibration information, and the calibration reliability or the reliability information transmitted in the calibration information transmitting,

and in which the calibrating is calibrating, by the calibration unit, the environmental measurement value that is measured by the second environmental sensor, based on the first calibration information that is received, according to the calibration reliability or the reliability information of the first sensor device.

[Item 6] The method according to item 5, in which the calibration information transmitting is performing, by the calibration information transmission unit, a control on the second sensor device in accordance with the calibration reliability or the reliability information of the first calibration information.
[Item 7] The method according to item 5, in which the reward transmitting is transmitting, by the reward transmission unit, a second control signal for performing a control on the first sensor device in accordance with the reward.
[Item 8] The method according to item 5, further including

storing of storing, by a storage device, the calibration reliability or the reliability information, in which

the reward transmitting is transmitting, by the reward transmission unit, the reward, based on a history of the calibration reliability or the reliability information stored in the storing.

[Item 9] The method according to item 8, in which

the calibration information transmitting is transmitting, by each of the calibration information transmission units in the plurality of first sensor devices, the first calibration information, and the calibration reliability or the reliability information of each of the first sensor devices,

the storing is storing, by the storage device, each of the calibration reliability or the reliability information that is transmitted in the calibration information transmitting, and

the reward transmitting is transmitting, by the reward transmission unit, information indicating that the first calibration information is desired to be transmitted, to the first sensor device that has transmitted the reliability information exceeding a threshold value of the calibration reliability, in the history of the calibration reliability or the reliability information.

[Item 10] The method according to item 9, in which

the calibration information transmitting is transmitting, by each of the calibration information transmission units in the plurality of first sensor devices, the first calibration information, and the calibration reliability or the reliability information of each of the first sensor devices,

the receiving is receiving, by the receiving unit, the first calibration information, and the calibration reliability or the reliability information of each of the plurality of first sensor devices,

the calibrating is weighting, by the calibration unit, the first calibration information in each of the plurality of first sensor devices according to the calibration reliability, and calibrating the environmental measurement value that is measured by the second environmental sensor, according to weighting of the first calibration information, and

the reward transmitting is transmitting, by the reward transmission unit, the reward to each of the plurality of first sensor devices in accordance with the calibration reliability.

[Item 11] The method according to item 5, in which when the reward transmission unit transmits a recommended time at which the calibration unit calibrates the environmental measurement value, and the environmental measurement value is calibrated at the recommended time, the reward transmitting is transmitting the reward in accordance with the calibration of the environmental measurement value at the recommended time.
[Item 12] The method according to item 6, in which when the reward transmission unit transmits a recommended time at which the calibration unit calibrates the environmental measurement value, and the environmental measurement value is calibrated at the recommended time, the reward transmitting is transmitting the reward in accordance with the calibration of the environmental measurement value at the recommended time.
[Item 13] The method according to item 7, in which when the reward transmission unit transmits a recommended time at which the calibration unit calibrates the environmental measurement value, and the environmental measurement value is calibrated at the recommended time, the reward transmitting is transmitting the reward in accordance with the calibration of the environmental measurement value at the recommended time.
[Item 14] The method according to item 8, in which when the reward transmission unit transmits a recommended time at which the calibration unit calibrates the environmental measurement value, and the environmental measurement value is calibrated at the recommended time, the reward transmitting is transmitting the reward in accordance with the calibration of the environmental measurement value at the recommended time.
[Item 15] The method according to item 9, in which when the reward transmission unit transmits a recommended time at which the calibration unit calibrates the environmental measurement value, and the environmental measurement value is calibrated at the recommended time, the reward transmitting is transmitting the reward in accordance with the calibration of the environmental measurement value at the recommended time.
[Item 16] The method according to item 10, in which when the reward transmission unit transmits a recommended time at which the calibration unit calibrates the environmental measurement value, and the environmental measurement value is calibrated at the recommended time, the reward transmitting is transmitting the reward in accordance with the calibration of the environmental measurement value at the recommended time.
[Item 17] The method according to item 11, in which

when a transmission command with a message to transmit the first calibration information is input to the first sensor device, the calibration information transmitting is transmitting, by the calibration information transmission unit, the first calibration information, and when the receiving unit receives, in the receiving, the first calibration information based on the transmission command at the recommended time, the reward transmitting is transmitting, by the reward transmission unit, the reward in accordance with the calibration of the environmental measurement value at the recommended time, and the reward in relation to the transmission of the first calibration information based on the transmission command.

[Item 18] The method according to item 11, in which

the calibration information transmitting is transmitting, by each of the calibration information transmission units in the plurality of first sensor devices, the first calibration information of each of the first sensor devices,

the receiving is receiving, by the receiving unit, the first calibration information of each of the plurality of first sensor devices, and

when the receiving unit receives, in the receiving, the first calibration information in each of the plurality of first sensor devices at the recommended time, the reward transmitting is transmitting, by the reward transmission unit, the reward weighted in order in which the first calibration information is received.

### EXPLANATION OF REFERENCES

10: receiving unit; 11: first environmental sensor; 12: providing unit; 13: calibration information transmission unit; 14: calibration unit; 15: control unit; 16: input unit; 18: AD conversion unit; 20: receiving unit; 21: second environmental sensor; 22: providing unit; 23: reward transmission unit; 24: calibration unit; 25: control unit; 28: AD conversion unit; 90: living body; 100: first sensor device; 110: computation unit; 112: storage unit; 120: computation unit; 122: storage unit; 200: second sensor device; 300: server; 310: server; 350: storage device; 400: sensor system; 501: measurement target; 502: measurement target; 503: target substance; 504: target substance; 508: interior space; 600: environmental sensor; 2200: computer; 2201: DVD-ROM; 2210: host controller; 2212: CPU; 2214: RAM; 2216: graphics controller; 2218: display device; 2220: input/output controller; 2222: communication interface; 2224: hard disk drive; 2226: DVD-ROM drive; 2230: ROM; 2240: input/output chip; 2242: keyboard.

What is claimed is:

1. A sensor system comprising:
a reward transmission unit which transmits a reward for calibration by a calibration unit, wherein
the calibration unit calibrates an environmental measurement value of a measurement target that is measured by a second environmental sensor, based on first calibration information for calibrating an environmental measurement value of a measurement target that is measured by a first environmental sensor.

2. The sensor system according to claim 1, further comprising:
a first sensor device having a calibration information transmission unit which transmits the first calibration information; and
a second sensor device having
a receiving unit which receives the first calibration information that is transmitted by the calibration information transmission unit, and
the calibration unit.

3. The sensor system according to claim 2, wherein the second sensor device has the reward transmission unit.

4. The sensor system according to claim 2, further comprising a server having the reward transmission unit.

5. The sensor system according to claim 2, wherein the measurement target of which the environmental measurement value is measured by the first environmental sensor, and the measurement target of which the environmental measurement value is measured by the second environmental sensor, are the same as each other.

6. The sensor system according to claim 5, wherein the second sensor device is arranged in an interior space, in the measurement target of which the environmental measurement value is measured by the second environmental sensor.

7. The sensor system according to claim 2, wherein
the calibration information transmission unit further transmits calibration reliability of the first sensor device, or reliability information in relation to the calibration reliability,
the receiving unit further receives the calibration reliability or the reliability information,
the calibration unit calibrates the environmental measurement value that is measured by the second environmental sensor, based on the first calibration information that is received, according to the calibration reliability or the reliability information of the first sensor device, and
the reward transmission unit transmits the reward in accordance with the calibration reliability or the reliability information of the first sensor device.

8. The sensor system according to claim 7, wherein the second sensor device performs a control in accordance with the calibration reliability of the first calibration information or the reliability information.

9. The sensor system according to claim 2, wherein the reward transmission unit transmits a second control signal for performing a control on the first sensor device in accordance with the reward.

10. The sensor system according to claim 7, further comprising:
a storage device which stores the calibration reliability or the reliability information, wherein
the reward transmission unit transmits the reward, based on a history of the calibration reliability or the reliability information stored in the storage device.

11. The sensor system according to claim 10, comprising:
a plurality of the first sensor devices, wherein
each of the calibration information transmission units in the plurality of first sensor devices transmits the first calibration information, and the calibration reliability or the reliability information of each of the first sensor devices,
the storage device stores each of the calibration reliability or the reliability information that is transmitted by each of the calibration information transmission units, and
the reward transmission unit transmits information indicating that the first calibration information is desired to be transmitted, to the first sensor device that has transmitted the reliability information exceeding a threshold value of the calibration reliability, in the history of the calibration reliability or the reliability information.

12. The sensor system according to claim 7, comprising:
a plurality of the first sensor devices, wherein
each of the calibration information transmission units in the plurality of first sensor devices transmits the first calibration information, and the calibration reliability or the reliability information of each of the first sensor devices,
the receiving unit receives the first calibration information, and the calibration reliability or the reliability information of each of the plurality of first sensor devices,
the calibration unit weights the first calibration information in each of the plurality of first sensor devices according to the calibration reliability, and calibrates the environmental measurement value that is measured by the second environmental sensor, according to weighting of the first calibration information, and
the reward transmission unit transmits the reward in accordance with the calibration reliability.

13. The sensor system according to claim 10, comprising:
a plurality of the first sensor devices, wherein
each of the calibration information transmission units in the plurality of first sensor devices transmits the first calibration information, and the calibration reliability or the reliability information of each of the first sensor devices,
the receiving unit receives the first calibration information, and the calibration reliability or the reliability information of each of the plurality of first sensor devices,
the calibration unit weights the first calibration information in each of the plurality of first sensor devices according to the calibration reliability, and calibrates the environmental measurement value that is measured by the second environmental sensor, according to weighting of the first calibration information, and
the reward transmission unit transmits the reward in accordance with the calibration reliability.

14. The sensor system according to claim 2, wherein
the reward transmission unit transmits a recommended time at which the calibration unit calibrates the environmental measurement value, and
when the calibration unit calibrates the environmental measurement value at the recommended time, the reward transmission unit transmits the reward in accordance with the calibration of the environmental measurement value at the recommended time.

15. The sensor system according to claim 3, wherein
the reward transmission unit transmits a recommended time at which the calibration unit calibrates the environmental measurement value, and
when the calibration unit calibrates the environmental measurement value at the recommended time, the reward transmission unit transmits the reward in accordance with the calibration of the environmental measurement value at the recommended time.

16. The sensor system according to claim 4, wherein
the reward transmission unit transmits a recommended time at which the calibration unit calibrates the environmental measurement value, and
when the calibration unit calibrates the environmental measurement value at the recommended time, the reward transmission unit transmits the reward in accordance with the calibration of the environmental measurement value at the recommended time.

17. The sensor system according to claim 5, wherein
the reward transmission unit transmits a recommended time at which the calibration unit calibrates the environmental measurement value, and
when the calibration unit calibrates the environmental measurement value at the recommended time, the reward transmission unit transmits the reward in accordance with the calibration of the environmental measurement value at the recommended time.

18. The sensor system according to claim 14, wherein
when a transmission command with a message to transmit the first calibration information is input to the first sensor device, the calibration information transmission unit transmits the first calibration information, and
when the receiving unit receives the first calibration information based on the transmission command at the recommended time, the reward transmission unit transmits the reward in accordance with the calibration of the environmental measurement value at the recommended time, and the reward in relation to the transmission of the first calibration information based on the transmission command.

19. The sensor system according to claim 14, comprising:
a plurality of the first sensor devices, wherein
when the receiving unit receives the first calibration information transmitted by the calibration information transmission unit of each of the plurality of first sensor devices at the recommended time, the reward transmission unit transmits the reward weighted in order in which the first calibration information is received.

20. A computer-readable medium having recorded thereon a program that, when executed by a computer, causes the computer to perform operations comprising:
calibrating an environmental measurement value of a measurement target that is measured by a second environmental sensor, based on first calibration information for calibrating an environmental measurement value of a measurement target that is measured by a first environmental sensor; and
transmitting a reward for calibration by the calibrating.
